(19) United States
(12) Patent Application Publication
(10) Pub. No.: US 2012/0259657 A1
(43) Pub. Date: Oct. 11, 2012

(54) Method and System for Analyzing Health Related Data of Patients

(75) Inventors: Amnon KEYNAN, Tel Aviv (IL); Amir WEINSTEIN, Petach Tikva (IL); Arturo WESCHLER, Kfar Saba (IL)

(73) Assignee: HEALARIUM INC., Wilmington, DE (US)

(21) Appl. No.: 13/525,761

(22) Filed: Jun. 18, 2012

Related U.S. Application Data
(63) Continuation-in-part of application No. 13/062,730, filed on Mar. 8, 2011.
(60) Provisional application No. 61/094,986, filed on Sep. 8, 2008.
(60) Provisional application No. 61/138,177, filed on Dec. 17, 2008.

(51) Int. Cl. G06Q 50/22

(52) U.S. Cl. 705/2

(57) ABSTRACT

System and method for analyzing health related data associated with a patient, comprising: an expert's station; a health database comprising health related data of patients; a wizard application, enabling the expert to create a template of commands for analyzing the health related data of the patient according to the expert's school of method, using a generic model associated with the expert's field of expertise, where the analysis calculates health related profile of the patient; a templates database comprising templates of commands created by experts; a generic models database, enabling the wizard to retrieve and store a generic model associated with the expert's field of expertise; and a main server for using the template of commands to analyze the health data of a patient, according to the analysis method of the expert, by operating the commands in the template for calculating health related profile of the patient.

### CROSS REFERENCE TO RELATED APPLICATION

This application is a CIP application of U.S. patent application Ser. No. 13/062,730 (publication No. US 2011/0166880 A1, filed on Mar. 8, 2011 as a national phase of PCT application No. PCT/IL/2009/00857, which in turn claimed the benefit of U.S. Provisional Patent Application 61/094,986, filed Sep. 8, 2008 and of U.S. Provisional Patent Application 61/138,177, filed Dec. 17, 2008, all above-mentioned applications are incorporated herein by reference in their entirety.

### FIELD OF THE INVENTION

The present invention relates generally to the field of systems and methods for analyzing, presenting and processing of data and more particularly, to systems and methods for analyzing, processing and presenting of health related data.

### BACKGROUND OF THE INVENTION

Health related data includes a variety of data types. Health related data may include a patient's personal details such as the patient's age, sex, height, weight and the like and can also be values of measurable parameters such as blood pressure, pulse, blood test results and the like, or parameters that are deduced from other measurable parameters such as Body Mass Index (BMI), which is the weight of the patient (e.g. in Kg) divided by the squared value of the patient's height (e.g. in meters): [Kg]/[M̂2].

To diagnose a patient and/or to identify the patient's health state, and provide the patient with a health care plan that is in correlation with the patient's health data, each professional expert has to view all related health data such as test results and the patient's personal details and decide upon the treatment according to the data as well as according to one or more school method the expert believes in or learned. For example, one of the experts may be a Dietitian that follows a first school of dieting and exercising method that asserts that a BMI of a female under the age of sixty should exceed the value of 20 before considering the patient to be over weighted, where a second dietitian only considers the value of BMI 20 as an overweight if the patient is under the age of twenty. Each of them may also have very different dieting and exercising programs. This means that the same patient having the same health data at a certain period of time in his/her life may receive different analysis results asserting a different health state relating to the same field of health and expertise of the experts.

It is obvious that some methods and systems for interpreting health related data and for treatment are proven better than others over time and study and that some experts have better success than others. Additionally, new and novel studies may change the knowledge and method of interpreting data and treatment for many experts in many realms of health related expertise.

Today, health data of patients is easy to store, retrieve and process, using computerized systems. Most Clinics and Health Organizations (HO) keep records of health related data and personal data of all their registered patients. Additionally, most clinics and HOs enable storing and presenting most if not all test results carried out in the organization for the expert physician or therapist to view and decide upon the patient's health condition. For example, physicians can view some if not all test results (e.g. blood/urine tests, X-ray results, personal details and many others) and the values of some measurable parameters (e.g. blood/urine tests results, pulse and blood pressure measures and the like) and decide whether the patient's measured values exceed a normal range or are considered dangerous to the patient according to standard normal ranges and also according to the patient's personal details and medical history.

Clinics and HOs do not provide tools that allow each expert to view a patient's health data in an organized manner that suits his/her school of method. There is also no tool provided for the experts allowing each expert to create his/her own personal tool using easily customizable generic tool or module, enabling to process the health data of a patient according to the expert's school of method to allow each expert to view indicators indicating the patient's health condition and profile according to the expert's definitions and conditions.

### SUMMARY OF THE INVENTION

The present invention, in some non-limiting embodiments thereof, provides a system and a method, enabling experts in various health related fields such as physicians, therapist, psychologists, dietitians, sports trainers and the like, to create their own personal analysis tools using a generic model that can easily be customized by the expert to allow using health data of patients, process this data according to conditions and commands defined by the expert and output a graphical representation of the patient's health factor and parameters according to the processing and presentation definitions customized by the expert.

The results of the processed health data may represent various aspects and presentations of the patient's health state(s) according to the expert's customized analysis. The resulting states may be presented to any authorized user such as at least one of: the patient, the expert and/or other experts.

According to one aspect of the invention, there is provided a system for enabling to analyze health related data associated with at least one patient. The system may comprise: (1) at least one expert's station, which is a computerized station of a health related expert; (2) at least one health database comprising health related data of patients; (3) a wizard software application operatively associated with the at least one expert's station, enabling the expert to create at least one template of commands for analyzing the health related data of the patient according to the expert's analysis school of method, using at least one generic model associated with the field of expertise of the expert, wherein the analysis calculates health related profile factors and condition of the patient; (4) at least one templates database, enabling to store templates of commands created by the expert; (5) at least one generic models database, enabling the wizard to retrieve and store a generic model associated with the expert's field of expertise; and (6) at least one main server, operatively associated with the wizard, the expert's station, the health database and the templates database, enabling to retrieve data from and store data in the databases and use the template of commands to analyze the health data of a patient, according to the analysis method of the expert. The analysis may be carried out by operating of the commands in the template, wherein at least one of the commands in the template enables calculating of at least one health related profile factor of the patient.

According to another aspect of the invention, there is provided a computer implemented method of enabling to analyze health related data associated with at least one patient. The method may comprise: (1) retrieving a generic model that is associated with the expert's field of expertise; (2) enabling the expert to create a template of commands, using the retrieved generic model, wherein said template allows analyzing health data of the patient according to the expert's analysis school of method; (3) receiving health related data of a patient; and (4) analyzing the received health related data according to the expert's template of commands by operating the commands of the template using health related data of said patient. The commands may enable calculating at least one health related profile factor of the patient.

According to yet another aspect of the invention, there is provided a computer implemented method of providing at least one suitable health related care plan of an expert to patients' health related goals. The method may comprise: (1) assigning suitability of the expert's care plan to possible patient's health related goals by customizing rules of at least one generic model enabling said assignment; (2) creating a suitability assignment template of the care plan, which includes all the customized rules of the generic model; (3) receiving at least one health related goal of a patient; (4) determining the suitability of known care plans in relation to the received goal, according to the suitability assignment template of each of the care plans, wherein the suitability is calculated according to the customized rules of the suitability assignment template in of each care plan in relation to the received goal; and (5) presenting care plans that are most suitable in relation to the received health related goal.

According to other aspects of the present invention, there is provided a system for building and supporting health related program that comprises: (a) a computerized support platform comprising at least one processor that operates a wizard for allowing experts, using expert terminal devices, to build generic health programs for patients, each such generic health program includes instructions structured as a set of rules and commands operable according thereto in a generic manner that allows operating the commands and/or changing their respective parameters according to received data; and at least one data storage for enabling storage and retrieval of generic health programs including the respective actionable care plans thereof. Each respective health program comprises actionable care plans. The generic configuration of the health programs allows the support platform to automatically personalize each respective health program for a specific patient by receiving personal input data of the respective patient and adapting the care plans of the respective health program, according to the respective health program's instructions and the input data.

The wizard may allow the expert to define actions of care plans and interrelations therebetween by providing and supporting an expert interface, where the interrelations comprise stages according to which the actionable care plans are executed. At least some of the actions may be scheduled according to a timeline, in which some of these actions preceding other actions trigger their respective other actions according to the timeline, where the timeline defines the care plans stages of the respective health program.

Optionally, the instructions of each generic health program comprise a set of interpretation rules and target setting rules. The interpretation rules determine how input data of the patient is interpreted for determining indexes of the respective patient. The target setting rules enable associating at least one target to each index set according to the interpretation rules, each respective target is associated with a set of interrelated care plans and allows executing and operating the respective associated care plans set in respect to the associated target.

Additionally or alternatively, the system further includes a patients manager and a supervision module, where the patient manager allows adapting the generic health programs to each respective specific patient by using observations inputted by the patient and creating respective patients' profile thereby, and the supervision module allows a supervisor, using a supervisor terminal to supervise the patients in performing their respective personal health programs.

Optionally, each health program also comprises a feedback layout allowing providing feedbacks to the patient in relation to the patient performances, wherein at least some of the actions are associated with feedback options triggering automatic feedbacks in relation to various progress situations. The feedback may include awarding the patient with incentive ranks. The supervision module may optionally enable the supervisor to provide online feedback to his/her patients.

According to some embodiments of the system, the support platform supports expert applications operated by experts' terminal devices and patient applications operated therethrough, wherein the expert application allows the expert to build health programs, monitor and feedback his/her patients through his/her terminal device using a designated expert interface and the user application allows the user to operate personal health programs and to receive feedback through his/her user terminal device using a designated user interface.

According to some embodiments, the system further enables the expert to associate content to each recommendation and/or action, wherein once operating the respective health program each recommendation or action that is associated with content is presented with its associated content or content indication. The wizard may further allow the expert to assign content or an indication linking thereto.

Optionally, each profile is created by receiving input data from each respective patient and calculating observations based on the input data, where the observations are then used to build the patient's respective patient's profile by using a designated profiler module operable through the support platform.

Additionally or alternatively, the care plans of a specific health program are configured in a hierarchal structure.

Optionally, the support platform further enables presenting the user with optional multiple suitable health programs selected from said data storage, wherein the suitable health programs are selected by the support platform according to predefined suitability conditions depending on the input data.

According to other aspects of the present invention, there is provided a method for building and supporting health related programs comprising: (a) providing a computerized support platform operating a wizard for allowing experts to build generic health programs; (b) building generic health programs for patients, wherein an expert uses the wizard through an expert terminal to build the generic health program, wherein each generic health program comprises instructions structured as a set of rules and commands operable according thereto in a generic manner that allows operating the commands and/or changing their respective parameters according to received data, wherein each respective health program comprises actionable care plans; (c) storing generic health programs including respective actionable care plans thereof; (d) receiving input data of a patient from at least one user terminal; and (e) automatically personalizing at least one health program by adapting the respective generic health program according to commands and instructions thereof and according to the received input data.

The method may further include supervising the progress of patients in performing their respective personal health programs, using a supervision module of the support platform used by a supervisor.

The method optionally further includes providing feedbacks to the patient in relation to the patient performances, wherein at least some of the actions are associated with feedback options triggering automatic feedbacks in relation to various progress situations, where the feedback comprises awarding the patient with incentive healthies ranks.

The method may additionally include providing online feedback to patients, wherein the expert enables providing such feedbacks through messaging and/or direct call communication enabled by the supervision module.

According to some embodiments, the building of a respective health program further comprises associating content to at least one of the actionable care plans, wherein once operating the respective health program each care plan that is associated with content is presented with its associated content or content indication.

Optionally, the method includes assigning each relevant content or an indication linking thereto to at least one content group and/or sub group.

The method optionally further includes creating a patient profile for each patient according to the input data thereof, using a patient application supported by a patients manager operated by the wizard, wherein the input data is translated into at least one observation, which is then used to build the patient's respective at least one profile by using a designated generic translation technique.

The method may optionally further include selecting and presenting the user with optional multiple suitable health programs selected from said data storage, wherein the suitable health programs are selected by the support platform according to predefined suitability conditions depending on said input data.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a block diagram, schematically illustrating a system for analyzing and presenting health related data, according to some embodiments of the invention;

FIG. 2 is a block diagram, schematically illustrating a main server of the system for analyzing and presenting health related data, according to some embodiments of the invention;

FIG. 3 is a block diagram, schematically illustrating a wizard for allowing a health related expert to customize and create templates for analyzing and presenting health related data, according to some embodiments of the invention;

FIG. 4 is a block diagram, schematically illustrating a generic model interface of a system for customizing of an analysis tool for health related data, according to some embodiments of the invention;

FIG. 5 is a block diagram, schematically illustrating an output presentation sheet presenting calculated health related profile factors of a patient, according to some embodiments of the invention;

FIG. 6 is a flowchart, schematically illustrating a method for customizing of an analysis tool for health related data, according to some embodiments of the invention;

FIG. 7 is a flowchart, schematically illustrating the process of customizing of an analysis tool for health related data, according to some embodiments of the invention;

FIG. 8A is a block diagram, care plans customization module for assigning suitability factors to experts care related plans and allowing experts to prepare and customize care plans, according to some embodiments of the invention;

FIG. 8B is a block diagram, schematically illustrating a plans retrieval application for enabling a user to retrieve health related plans according to the plans suitability, according to some embodiments of the invention;

FIG. 9 schematically illustrates a plans management application for managing presentation of care plans to patients, according to some embodiments of the invention;

FIG. 10 is a block diagram, schematically illustrating a plans-goals suitability customization tool, enabling an expert to define health related care plans and customize the rules and definitions associating the defined plans with possible patients' health related goals, according to some embodiments of the invention;

FIG. 11 is a flowchart, schematically illustrating a method for customizing a generic model for determining the suitability of a care plan to at least one patient's health related goal, according to some embodiments of the invention;

FIG. 12 is a flowchart, schematically illustrating the process of retrieving and presenting suitable care plans to a patient according to the patient's related properties and goal, according to some embodiments of the invention;

FIG. 13A is a block diagram schematically illustrating a system for supporting building, using and managing health programs, according to some embodiments of the present invention;

FIG. 13B schematically illustrates a main server supporting multiple building, users and supervision applications in respectively building generic health programs, using and supervising them, according to some embodiments of the present invention.

FIG. 14 is a schematic illustration of a hierarchal structure of a health program, according to some embodiments of the present invention;

FIG. 15 is a block diagram, schematically showing how a personal actionable health program can be built by an expert using system wizard tools, according to some embodiments of the present invention.

FIG. 16 is a flowchart, schematically illustrating a process of building personal health programs and using them, according to some embodiments of the present invention

FIG. 17 shows a graphical display of a patient's profile, according to some embodiments of the present invention.

FIG. 18A shows a recommendation object presentation of a diabetes management program including multiple recommendations associated with healthy eating, according to some embodiments of the present invention.

FIG. 18B shows tasks objects of a specific recommendation, according to some embodiments of the present invention.

FIG. 19A shows a specific task representation requiring reporting adherence related information therethrough, according to some embodiments of the present invention.

FIG. 19B shows a progress representation associated with the task representation of FIG. 19A, according to some embodiments of the present invention.

### DETAILED DESCRIPTIONS OF SOME EMBODIMENTS OF THE INVENTION

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The present invention, according to some non-limiting embodiments thereof, provides a system 100 and a method that enable at least one health expert 10 of one or more health related fields of expertise to create a personal analysis tool referred to herein as a “template of commands” that can (i) process and analyze health related data of patients 20 according to the expert's 10 school of method (analysis method); and (ii) present the analysis results (either to himself and/or to the patient 20) according to presentation and interface features that can be customized and/or defined by the expert 10.

The expert 10 in this document refers to any expert in one or more health related fields such as a physician, therapist, a psychologist, a dietitian, a sports trainer and the like.

The patient 20 may be any human or animal subject for whom the expert 10 carries out the profile analysis.

“health related data” and/or “health data” referred to in this document, relate to various data types relating to the patient 20, such as:
the patient's 20 personal details such as name, age, gender, address, phone number etc.;
measured parameters values associated with the patient 20 such as the value (in predefined units) of the patient's weight, height, blood pressure, pulse, blood/urine tests results, and the like;
deduced parameters values associated to the patient 20 such as BMI, relative values and the like; and/or
any other content (e.g. free text) describing the medical diagnosis or analysis of the patient relating to specific medical tests or examination.

The parameters and deduced parameters may be indexes and deduced indexes, respectively, indicating the patient's 20 input and deduced measures (e.g. blood pressure, pulse, weight, height BMI etc.) and personal details (age, name, ID number, etc.).

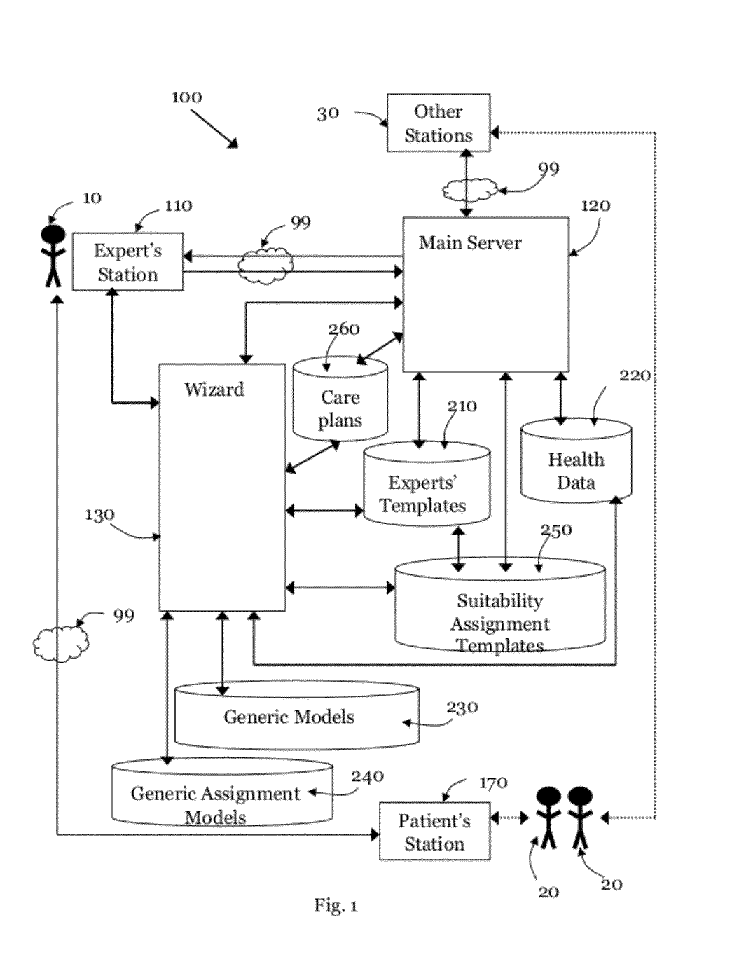

FIG. 1 is a block diagram, schematically illustrating a system 100 for customizing health related analysis tools, according to some embodiments of the invention.

According to these embodiments, the system 100 may comprise:
at least one expert's station 110, associated with at least one expert 10;
at least one main server 120;
a wizard 130 application;
at least one patient's station 170;
other stations 30;
at least one experts' templates database 210;
at least one health database 220; and
at least one generic models database 230.

The expert's station 110 may be any computerized unit that the expert 10 can use to view health related data, transit data, process health related data and/or input health related data of patients 20 such as, for example, a PC, a laptop computer, a mobile phone, a PDA device, etc.

The main server 120 may be any computerized unit enabling to process, transmit and retrieve data and communicate with a multiplicity of experts', patients' and other stations 110, 170 and/or 30 and other computerized terminals, as known in the art.

The patient's station 170 may be any computerized unit that the patient 20 can use to view and process health related data according to one or more Expert's 10 method, the Patient's station 170 may be, for example, a PC, a laptop computer, a mobile phone, a PDA device, etc.

The other station(s) 30 may be any other computerized unit(s) enabling other external personals such as other experts 10 or therapists (e.g. nurses and lab technicians who take measurements of the patient's 20 body measures such as pulse, blood pressure, blood counts etc.) to input patient's health data to be stored, for example, at the health database 220.

The health database 220 may be an external data base and/or an internal database that is stored in the main server 120.

The communication between at least two of: the experts' stations 110, the server 120, other stations 30,and the patient's stations 170; may be carried out over any one or more communication networks 99 known in the art such as the internet, intranet, wireless communication networks and the like.

According to some embodiments of the invention, wizard 130 may enable the expert 10 to use a generic model associated with the expert's 10 field of health related expertise (e.g. a generic model for the field of diets, a generic model for the field of sports etc.) to build a template of commands according to which patients 20 health related data is to be analyzed and processed to calculate profile factors and analyze the patient's 20 health related condition according to those factors.

The main server 120 may enable retrieving the template of commands created by the expert 10 and calculate those factors and carry out the analysis of a patient 20 health condition by operating the commands of the template (retrieving the template from the experts' templates database 210. The factors and overall analysis of the patient's health condition may be presented to the expert 10 and/or the patient 20, where the presentation may also be customized by the expert 10 using the wizard 130.

According to some embodiments of the invention, the system 100 may further enable experts 10 to determine suitability calculations for determining and presenting suitability of the expert's 10 health related care plan to patients 20 according to the patients' 20 possible health related goals (such as losing weight, reducing blood pressure, gaining weight, etc.) and according to the patient's 20 health related data. Therefore, the system 100 may further comprise a suitability assignment templates database 250; a care plans database 260; and a generic assignment models database 240.

The generic suitability assignment models database 240 may be operatively associated with the wizard 130 enabling the expert 10 to create a template of suitability assignments of the expert's 10 care plan(s) to patients' goals, using the wizard 130 by uploading a generic assignment model from the generic assignment models database 240 and using a generic assignment model associated with the expert's expertise to do so.

The suitability assignment templates database 250 may comprise templates of suitability assignments created by multiple experts 10 of one or more fields of expertise.

The wizard 130 may enable the expert 10 to customize rules in the generic model to determine the suitability between the expert's care plan and each possible patient's health related goals; creating a suitability template of the care plan, which includes all the customized rules.

Accordingly, the main server 120 may enable receiving a health related goal and health data of a patient 20; calculating the suitability of known care plans (of one or more experts 10) in relation to the received goal, according to each plan's suitability template, where the suitability is calculated according to the customized rules in the template of each care plan in relation to the received goal; and retrieving and presenting care plans that are most suitable with the received health related goal.

The system 100 may present a predefined number of the resulting most suitable care plans to the user (e.g. expert or patient) in a descending order of suitability.

The wizard 130 may enable the expert 10 to customize a generic model, which is a generic software tool that enables processing, transmitting, retrieving and presenting health related data. The customized generic model may be stored as a template of commands (that is the customized model), which may allow analyzing health related data of patients 20 (e.g. retrieved from the health database 220) according to the expert's 10 customization, and presenting the analysis results according to the customized presentation features also set by the expert 10 using the wizard 130.

According to some embodiments of the invention, as illustrated in FIG. 1, the wizard 130 may be operatively associated with at least one generic models database 230 enabling to store and retrieve generic models. For example, each generic model may be suited for a different medical or health field of expertise.

According to some embodiments of the invention, the Experts' templates database 210 may include templates of commands created by one or more experts 10 including the experts' 10 personal details associated therewith, to allow each expert 10 to use and/or customize his own personal template(s) and retrieve a selected template from the templates database 210.

Additionally, the health database 220 may include patient's 20 health related data such as the patients' 20 personal details, (e.g. a generic model for dietitians, for trainers, for cardiologists, etc.) to provide an expert 10 of a specific field with a generic model that already is adapted to the specific field e.g. comprising the suitable measure units, parameter types and profile types for the expert 10 to select from when customizing the generic model into a personally customized template of commands.

According to some embodiments of the invention, the resulting health related profile of a patient 20, resulting from the analysis carried out according to one expert's 10 template of commands may be used to deduce the health related goal or goals selected for searching suitable health care plans. The deduction may be carried out by the expert 10 and or any other user and/or by a predefined deduction algorithm in the system 100.

The wizard 130 may be a software application that may be operated by the expert's station 120, the main server 120 or partially at each of them. Accordingly, the wizard 130 may be installed at the main server 120 and/or at the expert's station 110.

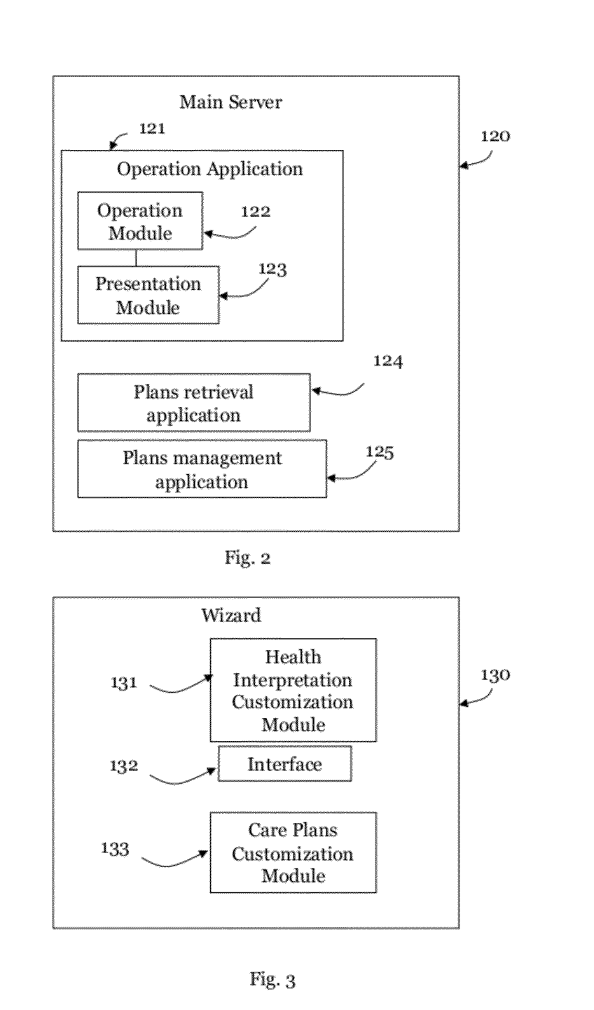

FIG. 2 is a block diagram, schematically illustrating the main server 120 of the system 100, according to some embodiments of the invention. The main server 120 may comprise:

an operation application 121 for operating the customized templates of commands for calculating and presenting of patient's 20 health related profile;

a care plans retrieval application 124, enabling to retrieve care plans that are most suitable to a patient's input goal; and
plans management application 125 for allowing the patient 20 to report progress of following the care plan chosen by the patient 20 according to the suitability presentation and for monitoring the patient's 20 implementation of the selected plan.

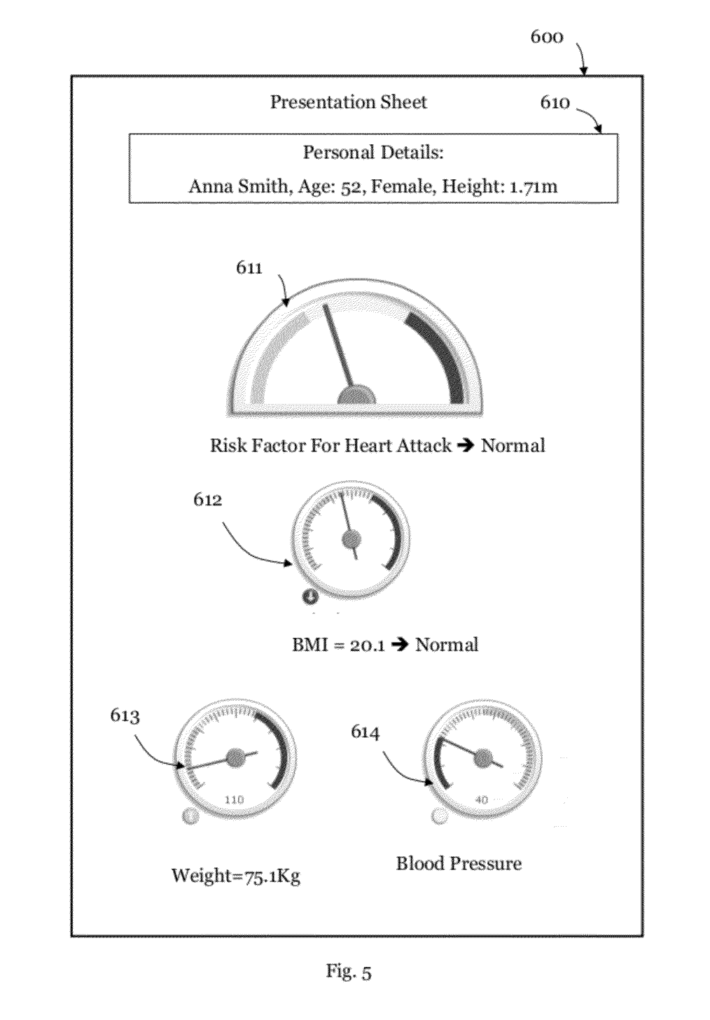

The operation application 121 may comprise an operation module 122 for carrying out the retrieval, transmission and processing of the data and a presentation module 123 for carrying out the presenting of profile sheets (e.g. see FIG. 4) for presenting the patient/expert of the patient's resulting health related profile, and health condition (e.g. to show the patient/expert whether the profile factors and/or parameters exceed normal ranges etc.

According to some embodiments of the invention, the operation and presentation modules 122 and 123 may be able to allow the expert 10 to:
(i) retrieve his or others' template from the experts' templates database 210 by identifying himself or the desired template;
(ii) retrieving input parameters of a specific patient 20 by following the commands in the template to retrieve the appropriate data from the health database 220, by inserting some predefined personal details of the patient 20 to allow identifying the patient 20 (e.g. the patient's ID number);
(iii) manipulating (analyzing) the parameters according to commands of the template e.g. to produce profile factors values and profile stratus, the deduced parameters values and to analyze these values positioning in correspondence to the correct ranges according to the predefined conditions; and
(iv) presenting the values of the profiles/parameters showing their positioning in correspondence to the ranges of values relating to each particular presented profile/parameter, according to predefined prioritized presentation setup, customized by the expert 10.

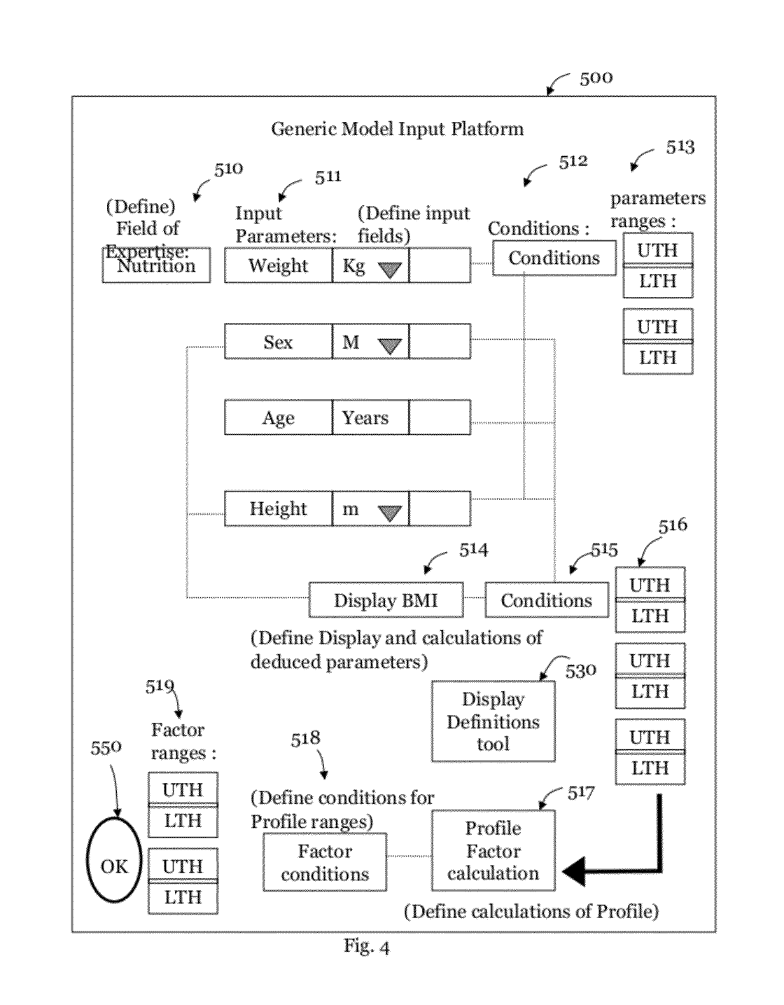

FIG. 3 is a block diagram, schematically illustrating the wizard 130, according to some embodiments of the invention. The wizard 130 may comprise:

a health interpretation customization module 131, for enabling the expert 10 to customize a health related generic model;

an interface 132 for allowing the expert 132 to input and view data for customizing the generic model and for associating suitability to care plans; and

a care plans customization module 133 for associating suitability to care plans.

The interface 132 may include various interface platforms (e.g. selected through a menu) for allowing the expert 10 to either customize a generic model for creating a template of commands or for assigning suitability factors to care plan(s).

FIG. 4 is a block diagram, schematically illustrating an input platform 500 of the wizard 130 for allowing the expert 10 to customize and create templates of commands for analyzing and presenting health related data, according to some embodiments of the invention.

According to these embodiments, the input platform 500 may include:

at least one field of expertise input field 510, enabling the expert 10 to define the general and/or sub field of his/her expertise (e.g. dietitian and dietitian for vegetarians);

at least one parameter definition input field 511, enabling the expert 10 to define parameter types (such as height, weight, etc.) that are important for his method of calculating each patient's 20 profile (e.g. by selecting parameters types out of a predefined list related to the selected or defined field of expertise);

parameters' conditions input fields 512 and parameters' ranges definition fields 513, enabling the expert 10 to define conditions according to which a value of an input parameter will be considered within/above/below a defined range of corresponding values, and to set upper and lower thresholds for each condition—defining each such range;

at least one deduced parameter input field 514, enabling the expert 10 to define a parameter that can be deduced from at least one other input parameter;

at least one deduced parameters' condition input filed 515 and deduced parameters' ranges definition fields 516, enabling the expert 10 to define conditions according to which a value of a deduced parameter will be considered within/above/below a defined range of corresponding values, and to set upper and lower thresholds for each condition - defining each such range;

at least one profile calculation field 517 enabling the expert 10 to define the way in which each profile is to be calculated (e.g. by defining a mathematical formula for calculating a profile value, where at least some of the parameters (either input and/or deduced) are the parameters of the formula); and

at least one profiles condition input filed 518 and profiles' ranges definition fields 519, enabling the expert 10 to define conditions according to which a value of a profile will be considered within/above/below a defined profiles' range of corresponding values, and to set upper and lower thresholds for each condition—defining each such range.

Additionally, the expert 10 may be able to define the measure units for each input and/or deduced parameter (e.g. by selecting the units out of a predefined list associated with each parameter type).

For example, a nutrition expert 10 may define his field of expertise 510 and then automatically view selection options for input and deduced parameters related to this expertise such as, weight, gender, height, calories intake, BMI and the like; as well as the related optional units associated with each parameter (e.g. weight can be in pounds, Kg and the like) enabling the expert 10 to select his/her favorable units. The deduced parameters may automatically be in units that correspond to the units selected for the input parameters ion which they depend.

For each input and/or deduced parameter and/or profile value, the expert 10 may be required to use the generic model to define threshold values for each parameters defining the “normality range” of values and the conditions for the defined ranges. For example, the expert 10 may define that a weight range between 50-80 Kg is considered “normal range” only under the conditions: female, between the age of 16-99 years, of height that is between 1.49-1.70 meters; whereas for male of height range of 1.78-1.99 meter and from age 21 and on the weight range may be between 55-90 Kg. Patients 20 that fall within the conditions of a certain set of values range may be checked for their values position within that range, defining the health states of the patient 20 (e.g. over/under weight, high/low risk for heart related diseases, etc.), to see whether the patient's 20 value exceeds the parameter's range (either above an upper threshold value or below a lower threshold value). This may require defining interrelations between the fields and parameters values.

Additionally, as illustrated in FIG. 4, the input platform 500 may further comprise a display definition tool 530 enabling the expert 10 to define the graphical presentation of each profile and/or parameter according to which the presented patient's 20 profiles and parameters will be presented using the presentation module 122.

According to some embodiments of the invention, the display definition tool 530 may further allow the expert 10 to define which parameters and/or profiles will be presented in the output presentation and in what order and the graphical manner in which the patient's 20 states (each state relating to a parameter or a profile representing the positioning of the value of the parameter/profile within the defined range associated with the parameter/profile). For example, a certain profile may be presented first as a scale indicating the profile's value according to a presentation of the range of values of this profile showing the position of the patient's 20 value in the scale in a graphical manner. Other profiles may appear in a prioritized manner below the main profile.

Each expert 10 of the same field of expertise may select different profiles as their main ones and assign different priorities. For example, one nutritionist may consider the statistical factor indicating the chances of the patient to get a heart related disease is more important that the profile indicating the statistical factor indicating the chances for having lung related diseases and therefore decide on presenting the first profile and then the second one followed by all the input and deduced parameters' values' representations.

Once all input and deduced parameter and profile fields 510-511, 514 and 518; once all their conditions and ranges 512, 513, 515, 516 and 519; and the profile calculation and presentation features are defined 517 and 530; all these definitions may be translated by the wizard 130 into commands, which may be stored as a template of commands that is associated with the expert's 10 identifying details in the experts' templates database 210. The translating of the definitions and the saving of the template may be carried out once the user approves all his/her selected and defined fields, ranges, conditions and so forth, e.g. by pressing a virtual OK button 550, as illustrated in FIG. 4.

The operating application 121 may be operatively associated with the main server 120 and/or the experts stations 110, enabling to produce patients' profile sheets presenting the health profile of each patient 20, by retrieving the expert's 10 specific template of commands, retrieving health data of the patient 20 form the health database 220 according to the commands in the template, processing and analyzing the patient's 20 health data according to these commands, to produce deduced parameters values and/or profile factors, and presenting at least part of the produced parameters and factors, according to the commands of the template.

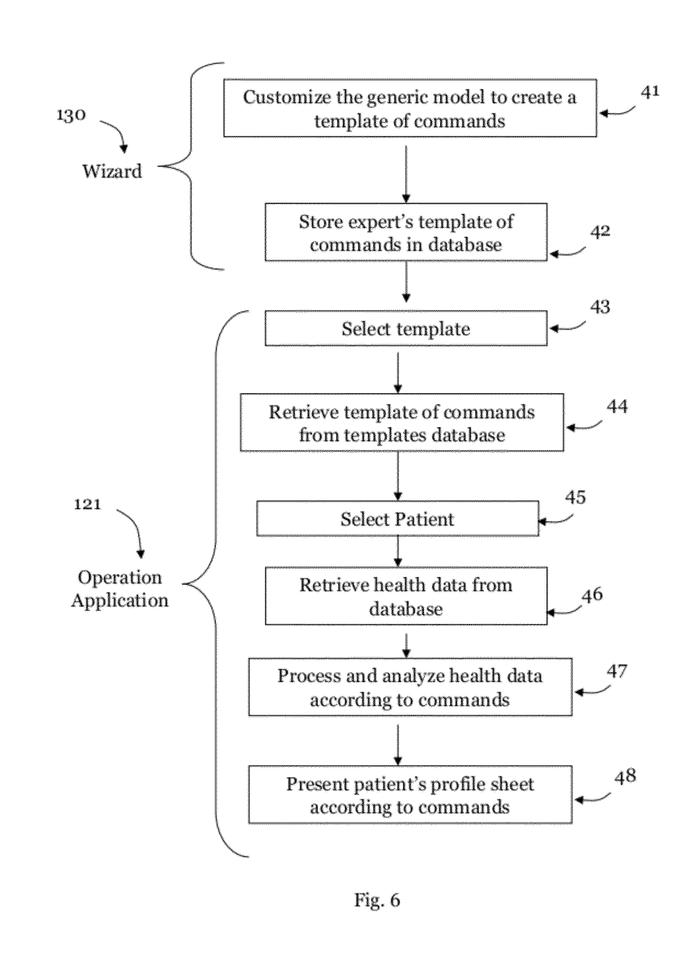

FIG. 5 schematically illustrates a profile sheet 600 of a patient, according to one expert's 10 template commands and definitions. According to this sheet 600. The personal details 610 of the patient may be automatically presented in the sheet. Additionally, A first main profile graphical indication 611 may present a scale icon showing the defined range of values, where the normal range is marked differently than the lower and/or upper range (e.g. by three different colors defining each range). The value of each of the patient's 20 profile factor may be marked by a line pointing to the value of the factor within the scale that is marked by the ranges. Each deduced parameter presentation 612 may be presented beneath the main profile factor(s) presentation 611 in a similar graphical manner as well as other input parameters 613 and 614, such as weight and blood pressure for example.

The profile factors may be any calculated value or estimation relating to the patient's 20 health associated with the expert's 10 field of expertise and his/her method of analyzing the patient's 20 health data.

The ranges may define what is considered a “normal value” of a parameter or an estimated health factor (e.g. the chances of getting a heart attack) of a patient 20 according to the expert's 10 analysis method, where upper and lower threshold values may define abnormal values exceeding the normal range (where the values are either above the upper threshold or below the lower threshold values).

The positioning of the patient's parameter, deduced parameter or profile within the defined range may represent the “state” of the patient according to the expert's 10 analysis method. For example, the patient 20 may be considered to have an overweight when the weight parameter of the patient 20 exceeds an upper threshold defined in the weight range by the expert 10.

According to some embodiments of the invention, the presentation of the estimated profile factor(s) of the patient 20 and the positioning of each represented factor or parameter in relation to a scale defining the ranges for “normal values” and “exceeding values”—may be graphical for the convenience of the expert 10.

The input parameters values may be retrieved from the health database 220, which may include all available health data of each patient 20 including each patient's personal details (e.g., name, age, gender, etc.), test results (e.g. blood pressure, pulse, etc.), measured details (e.g. weight, height etc.) and the like.

The profile may be one or more estimations of the patient's 20 health condition or state in relation to the expert's 10 field of expertise and school of method. For example, the profile may be a statistical factor that predicts the chances of the patient 20 to get heart diseases in relation to weight related data, according to a method of a dietitian expert 10 that follows (e.g. according to studies he/she follows) a certain method for calculating that statistical factor taking into consideration the patient's 20 age, gender, weight, height, calculated BMI, and country of birth.

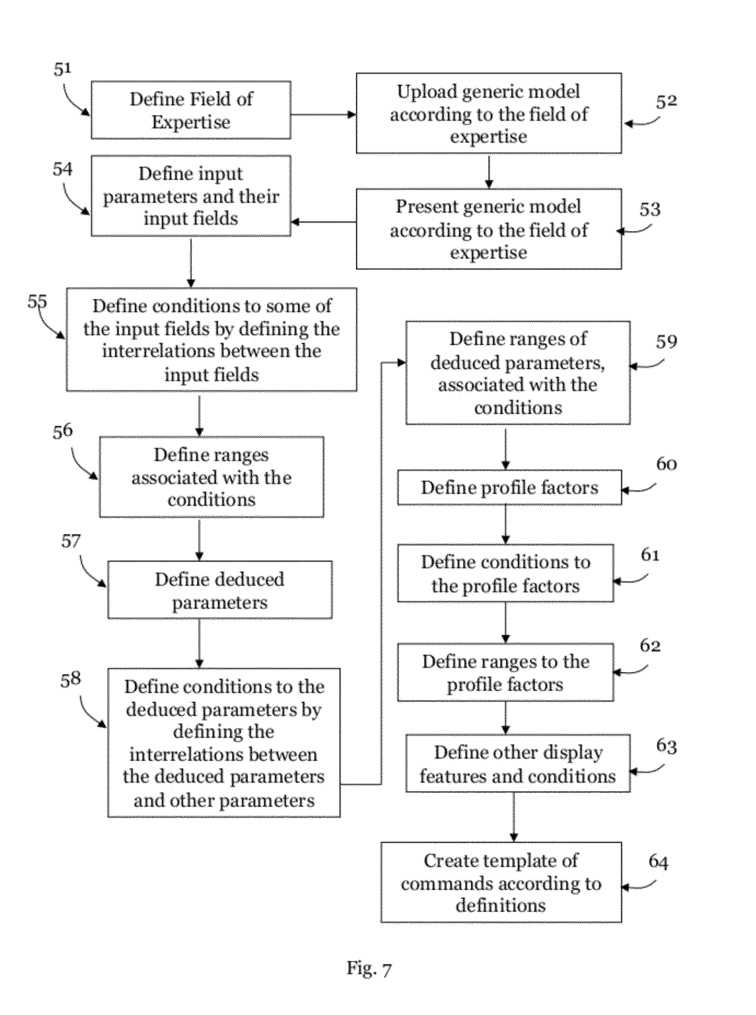

FIG. 6 is a flowchart, schematically illustrating a process of customizing templates and presenting of patients' 20 health related profile sheets 600 comprising various parameters and factors related to the patients' health according to the expert's field of expertise and analysis method.

According to these embodiments, the process may include:

customizing a generic model to create a template of commands 41, using the wizard 130, where the template of commands is a customization analysis tool for health related data;

storing the created template of commands 42 in at least one experts' templates database 210, where steps 41-42 may be carried by the expert 10 using the wizard 130;

selecting a template of commands 43, where the operation application 121 enables the expert 10 to select a desirable analysis tool to work with either out templates associated with the expert 10 or any other shared templates;

retrieving the selected template 44, which may be retrieved from the at least one templates database 210;

selecting a patient 45, where the expert 10 can select a patient 20 by giving some predefined identifier(s);

retrieving health related data 46 from the at least one health database 220 according to the patient's 20 identity and the application's 121 definitions and rules and according to the template commands defining which data to retrieve from all data stored associated with the patient 20;

processing and analyzing of the health data 47, according to the template's commands; and

presenting of a health profile sheet 48, according to presentation commands of the template.

According to some embodiments of the invention, steps 43-48 may be carried out by the operation application 121, which enables processing and analyzing of the patient's 20 health data and presenting of a health profile sheet 600, according to the template commands, where the template is a customized health analysis tool customized by either the same expert 10 to whom the sheet 600 is presented or any other expert 10 in a health related field.

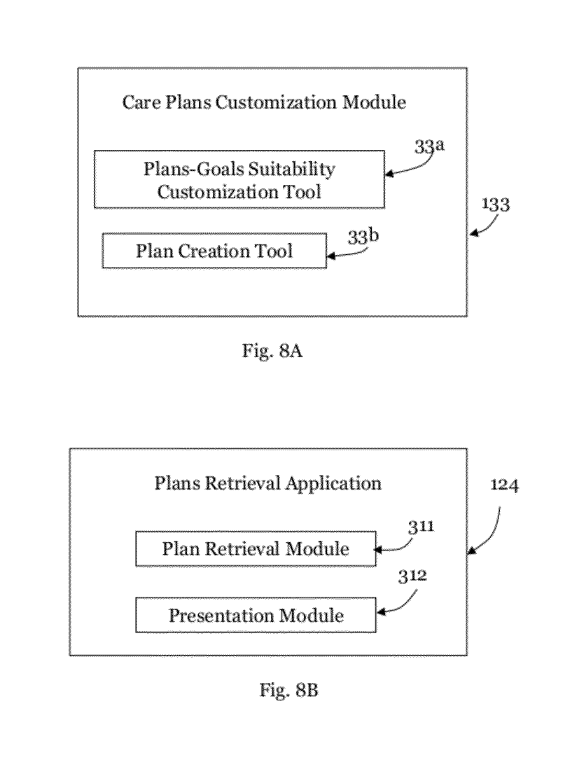

FIG. 7 is a flowchart, which schematically illustrates the process of customization 41 of the generic model in further details, according to some embodiments of the invention. To carry out the customization, the expert 10 may be required to use one or more input platforms 500 of the generic model, provided through the wizard 130.

According to these embodiments, the process may comprise at least some of the steps of:

defining a field of expertise 51, where the expert 10 selects or inserts his/her field of expertise;

uploading 52 and presenting 53 a generic model input platform(s) 500, according to the defined field of expertise from the generic models database 230;

defining input fields of input parameters 54, where the platform 500 enables the expert 10 to define the parameters the expert 10 wishes to retrieve from the health database 220 to process and view by defining these parameter types as input fields, where the wizard 130 enables the expert 10 to select parameters and definitions out of predefined existing input fields and parameters, which are associated with the field of expertise;

defining conditions to at least some of the input parameters 55, where the conditions may be created by defining interrelations between some of the input fields;

defining the value ranges for each input parameter 56 by defining an upper and a lower threshold values defining the normal range therebetween and the exceeding ranges of parameter values, wherein each range associated with each input parameter may also be defined by the conditions;

defining deduced parameters 57, where the platform 500 enables the expert 10 to define the deduction mathematical and logical deduction;

defining conditions to at least some of the deduction parameters 58, where the conditions may be created by defining interrelations between some of the input parameters;

defining the value ranges for each deduced parameter 59 by defining an upper and a lower threshold values defining the normal range therebetween and the exceeding ranges of deduced parameter values, wherein each range associated with each input parameter may also be defined by the conditions;

defining profile factors 60, where the platform 500 enables the expert 10 to define the mathematical and logical calculating formula/algorithm for each factor (e.g. by using other deduced and/or input parameters and statistical algorithms);

defining conditions to at least some of the factors 61 where the conditions may be created by defining interrelations between some of the input parameters and deduced parameters;

defining the value ranges for each factor 62 by defining an upper and a lower threshold values defining the normal range therebetween and the exceeding ranges of factor's values, wherein each range associated with each factor may also be defined by the conditions;

defining other display features 63, such as the graphical presentation of each factor, deduced parameter and/or input parameter; and creating a template of commands 64 according to all above mentioned definitions and conditions.

The template of commands, may then be saved in the template database 210 along with the expert's 10 details (e.g. name, field of expertise etc.) to allow associating the template with the expert 10 who created it.

The template may be used later on as an analysis software tool comprising or attaching to other command codes that enable the expert 10 to view patient's 20 analyzed data according to the expert's 10 definitions and analysis method. The analysis tool may comprise an interface enabling the expert 10 to input his/her personal identification and the patient's identifying input to enable the analysis tool to then use the identification data of the expert 10 to retrieve the correct template of commands and the patient's 20 identifying data to retrieve the patient's 20 health data from the health database 220 and to allow then to analyze the patient's 20 data by following the commands in the template using the health data of the patient 20 that was retrieved.

According to some embodiments of the invention, experts 10 may use other expert's 10 templates of commands by using the analysis tool and identifying the expert 10 of which template they wish to use.

Additionally or alternatively, the analysis tool may comprise security applications to only allow authorized users (e.g. experts 10) to retrieve templates they are authorized to use.

According to some embodiments of the invention, both the process of analyzing the health data according to the template of command and the creating of the template may be carried out in the main server 120, where the process of inputting the identifying data of the expert 10 and patient 20 may be carried out in the expert's station 110. Using the network(s) 99 to transmit and receive data, as known in the art.

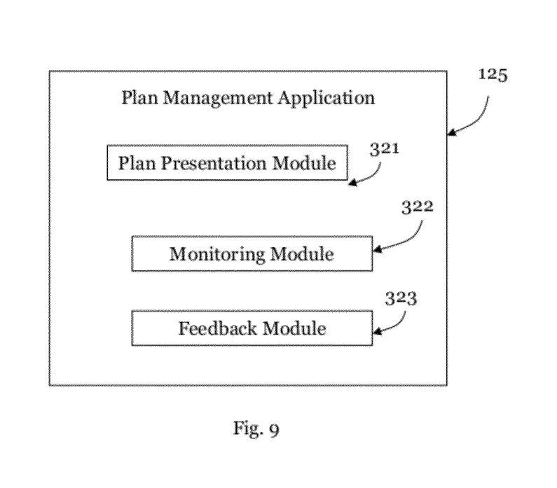

FIG. 8A is a block diagram, schematically illustrating the care plans customization module 133 for assigning suitability factors to experts health related plans, according to some embodiments of the invention.

The care plans customization module 133 may comprise a plans-goals suitability customization tool 33a and a plan creation tool 33b.

According to embodiments, the plans-goals suitability customization tool 33a may enable the expert 10 to retrieve at least one generic assignment model (e.g. from the generic assignment models database 240) that may allow him to define the manner in which the suitability of his or another expert's 10 care plan will be calculated in relation to one or more possible received health related goals and optionally also in relation to at least some of the patient's health related data (e.g. weight, age, gender etc.). The defining of the manner in which the suitability is calculated may be carried out by customizing predefined generic definitions and rules of the generic assignment model.

The resulting customized assignment model may be a suitability assignment template that may be stored as a suitability assignment template in the suitability assignment templates database 250, which may include rules for determining a suitability factor(s), which indicate(s) the level of suitability between the plan and each of the possible goals and the patient's properties. The rules of the template may be computer readable commands enabling the plans retrieval application 310 to calculate the suitability factor upon receiving the goals and the patient's properties by, for instance inputting the goal, the health parameters and personal properties of the patient 20 into a function, which is the embodiment of the computer readable commands (rules), and calculating the resulting suitability factor by applying the function upon the parameters and goal.

FIG. 8B is a block diagram, schematically illustrating the plans retrieval application 124 for enabling the patient 20 or the expert 10 to retrieve health related care plans according to the plans suitability to the patient's 20 health related goal, according to some embodiments of the invention.

The plans retrieval application 124 may comprise: a plans retrieval module 311; a presentation module 312.

According to embodiments, the plans retrieval module 311 may enable retrieving suitability assignment templates of various care plans and receiving/retrieving at least one of the health related goals and properties of a patient 20 and calculating the suitability level of each plan by operating the commands of the template's rules upon the inputted and/or retrieved patient's goal and properties. The plans retrieval module 311 may further include an interface enabling the patient 20 to select a favorite care plan.

According to embodiments, the presentation module 312 may enable sorting the resulting retrieved care plans according to predefined sorting rules and priorities (E.g. according to a decreasing effectiveness rate), enabling to present the most suitable plans according to the plans' suitability level in relation to the received patient's goal.

According to embodiments, the monitoring module 313 enables automatically monitoring the patient's progress in performing the selected favorite plan and notifying the patient 20 when the plan is not followed properly. For example, a monitoring table may be provided allowing the patient 20 to insert information according to predefined fields on periodic or scheduled basis (e.g. each day of a predefined time-period). For example, the patient may be required to specify his daily quantities and types of food consumed by the patient 20 to verify whether or not the patient is following a diet plan. The monitoring module 313 may enable processing the inserted data to monitor the patient's progress. Once the monitoring module 313 identifies inconsistencies with the plan in relation to the goal, the monitoring module 313 may enable notifying the patient 20 regarding those inconsistencies, via any predefined notification methods and techniques (e.g. via mail, SMS messages etc. using predefined text messages, or by highlighting exceeding quantities inserted by the patient 20 etc.). The monitoring module 313 may further enable the patient 20 to define alert parameters and destinations (e.g. to what device and in what manner will the alert be transmitted and presented).

According to embodiments, the feedback module 314 may enable patients 20 to feedback on the plans either by allowing them to insert free text comments and/or through predefined feedback fields that may allow the experts 10 to improve their knowledge regarding the success of theirs and others plans in order to enable updating their templates according to acquired knowledge.

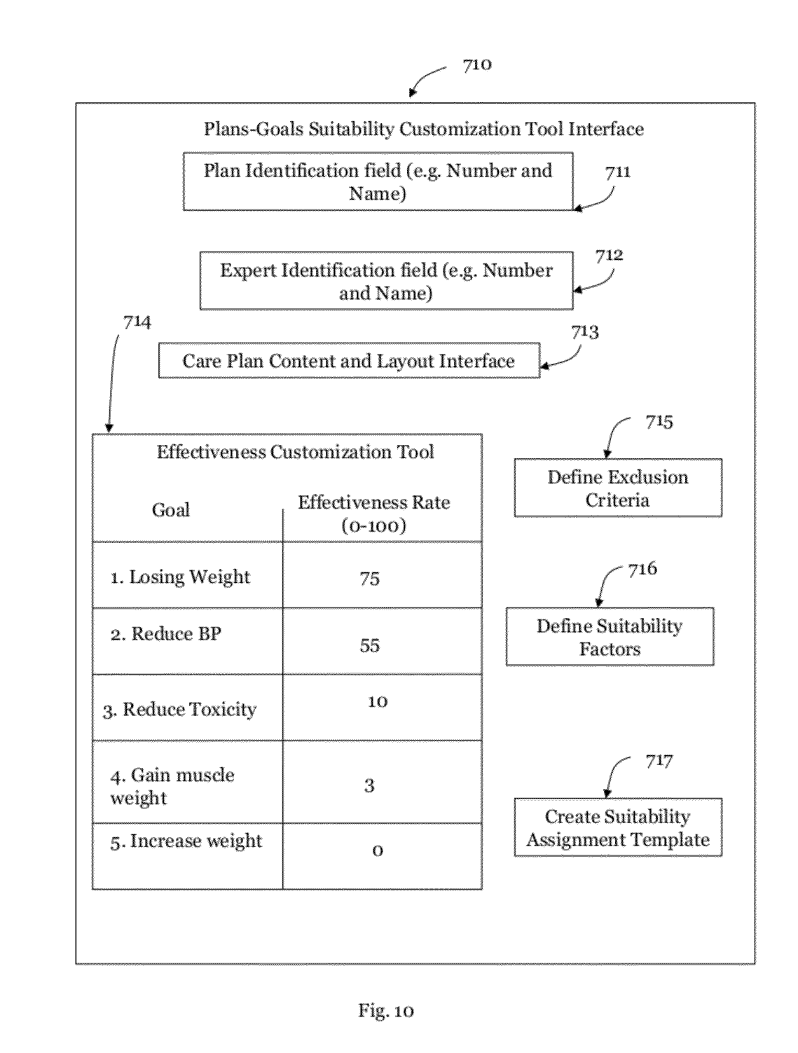

FIG. 9 schematically illustrates the plans management application 125 for managing presentation of care plans to patients that is operated by the main server 120, according to some embodiments of the invention.

The plans management application 125 may comprise:

a plan presentation module 321, enabling to present a selected care plan to the patient 20;

a monitoring module 322 which enables executing the monitoring and alerts commands of a retrieved selected care plan and thereby allow the patient 20 to input parameters and information relating to the patient's 20 implementation of the care plan, according to the plan's structure and presentation features, and to be presented with alerts relating to exceeding values or input information; the monitoring module 322 may additionally monitor the patient's 20 implementation of the care plan according to the monitoring rules set by the expert 10; and a feedback module 323 enabling the patient 20 to insert feedback content (e.g. text, voice, and the like) to the plan, where the content of the feedback may be automatically stored and transmitted to the expert 10 and/or automatically stored along with the patient's 20 information (e.g. the goal, the patient's 20 properties etc.) for further analysis and/or rating of care plans.

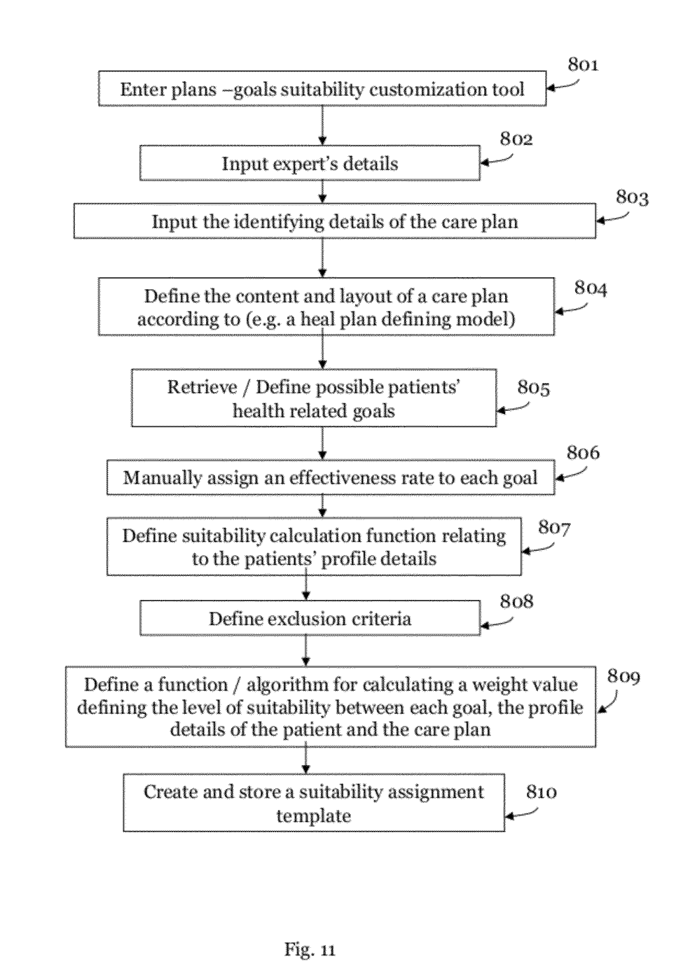

FIG. 10 is a block diagram, schematically illustrating an interface 710 of the plans-goals suitability customization tool 33a, enabling the expert 10 to define health related care plans and customize the rules and definitions associating the defined plans with possible patients' health related goals, according to some embodiments of the invention.

According to these embodiments, the interface 710 may comprise a plan identification input field 711, an expert identification input field 712, a care plan content and layout interface 713, an effectiveness customization tool 714, an exclusion criteria definition tool 715, a suitability definition tool 716 and a suitability assignment template creation tool 717.

According to embodiments, the plan identification input field 711 may enable the expert 10 to name a new or an updated plan.

According to embodiments, the expert identification input field 712 may enable the expert 10 to input his/her identification properties (e.g. name, docket number, field of expertise etc.).

According to embodiments, the care plan content and layout interface 713 may allow the expert 10 to either retrieve or select an existing care plan or create and define the content and layout of a new plan. For example, the care plan content and layout interface 713 may include predefined input fields such as: a free text content filed enabling the expert 10 to textually describe his care plan and its benefits; a timeline table enabling the expert to define the actions the patient 20 is required to perform or participate and the frequency and schedule of these actions (e.g. a timeline specifying the time in each day when the patient 20 is required to perform a physical exercise and the specification of each exercise at the indicated timing).

According to embodiments, the effectiveness customization tool 714 may be an interface table enabling the expert 10 to define/select/download a list of possible patients' health related goals and manually assign an effectiveness rate to each goal on the list.

The effectiveness rate may indicate how effective the plan is in relation to each health related goal on the list.

According to embodiments, the exclusion criteria definition tool 715 may enable the expert to define one or more conditions under which the plan is defined as “un-recommended” for the patient 20. These conditions may enable excluding the plan from being presented to the patient 20. The conditions may relate to possible values or properties of patients 20 taken from the patients' properties. For example, the expert 10 may define that his/her plan in un-recommended for patients 20 under the age of twenty or for patients 20 who suffer from low BP under a threshold BP value.

To allow the expert 10 to define those conditions, the exclusion criteria definition tool 715 may include all predefined fields that correspond to predefined properties of patients 20 in the system 100. For example, the system 100 may be preset to receive patients' 20 properties that include the patients' date of birth, sex, height (in meters), BP value and weight (in Kg). Correspondently, the exclusion criteria definition tool 715 may allow the expert 10 to define threshold values of at least one of the properties and optionally, define exclusion criteria of the plan in relation to the patient 20 by defining combination of exceeding values of the patient's 20 properties. For example, the expert 10 may define that the plan is only defined as “excluded” for patients 20 that are under the age of twenty and also weighs under 60Kg.

According to embodiments, the suitability definition tool 716 may allow the expert 10 to define a function for calculating a level of suitability of the plan to the patient 20, according to the patient's properties. For example, the suitability definition tool 716 may enable the expert 10 to define a mathematical function for calculating the suitability value of a patient when inserting values of predefined properties of the patient 20. For example, a function that calculated the suitability value in relation to the patient's 20 weight, age and height.

According to embodiments, the suitability assignment template creation tool 717 may allow the expert to store all the definitions and functions and create a template that converts all defined and inserted properties into rules which may be computer readable commands enabling to receive the patient's 20 goal and properties as an input, process the input data according to a predefined processing method and output at least one of, for example, exclusion criteria result (yes/no); effectiveness value; and/or suitability value of each of the processed plans in the template.

According to embodiments, the system 100 may further allow receiving a multiplicity of health related goals, associated with the same patient, and assign a weight factor for each goal associated with each of the searched care plans (e.g. according to the effectiveness rate of each plan in relation to each goal), and determine the most suitable care plan according a predefined calculation function/algorithm (e.g. statistical calculation function).

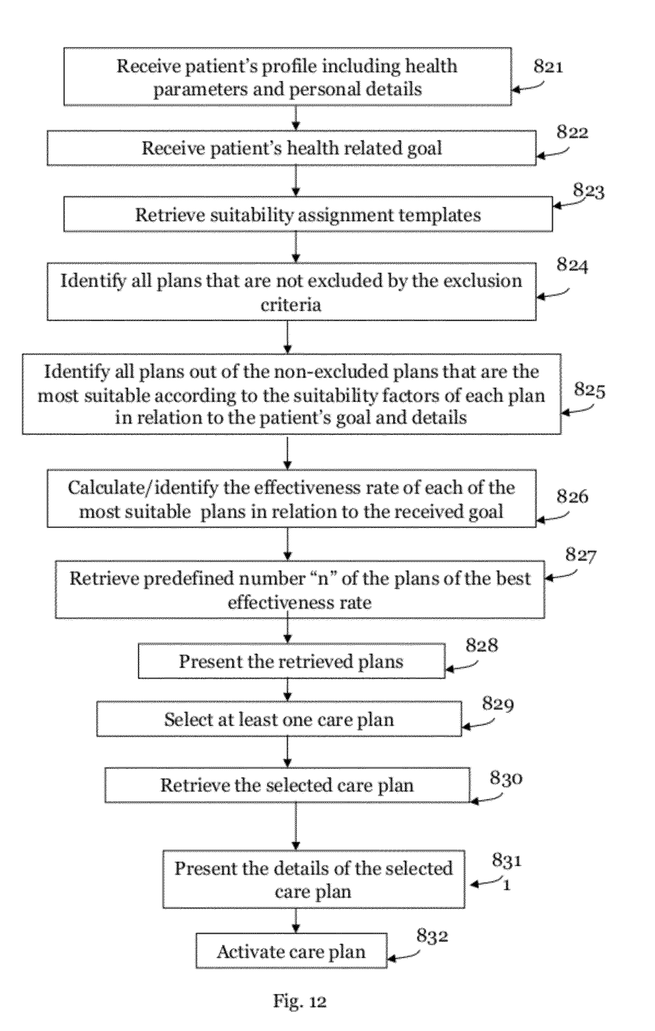

FIG. 11 is a flowchart, schematically illustrating a method for customizing a generic model for determining the suitability of a care plan to at least one patient's health related goal, according to some embodiments of the invention. The method may comprise at least some of:

entering the plans-goals suitability customization tool interface 801;

inputting the identification properties of the expert 802;

inputting the identifying properties of the care plan 803;

defining the content and layout of the care plan 804 (e.g. using the plan creation tool and interface or retrieving a former tool and customizing it);

retrieving/defining possible health related goals 805;

manually assigning an effectiveness rate to each goal 806;

defining suitability calculation function, where the function enables calculating a suitability factor of the care plan to each goal according to at least some of the health related data of the patient 807;

defining exclusion criteria 808;

defining/selecting a function/algorithm for calculating a weight value for each possible goal 809, which may indicate the total level of suitability of the plan in relation to each goal and the patient's properties; and

Creating a suitability assignment template 810 including rules for calculating and outputting, for example, the effectiveness rate, an exclusion criteria result (Y/N), a suitability factor and the suitability weight value for each inputted or received goal of the plan.

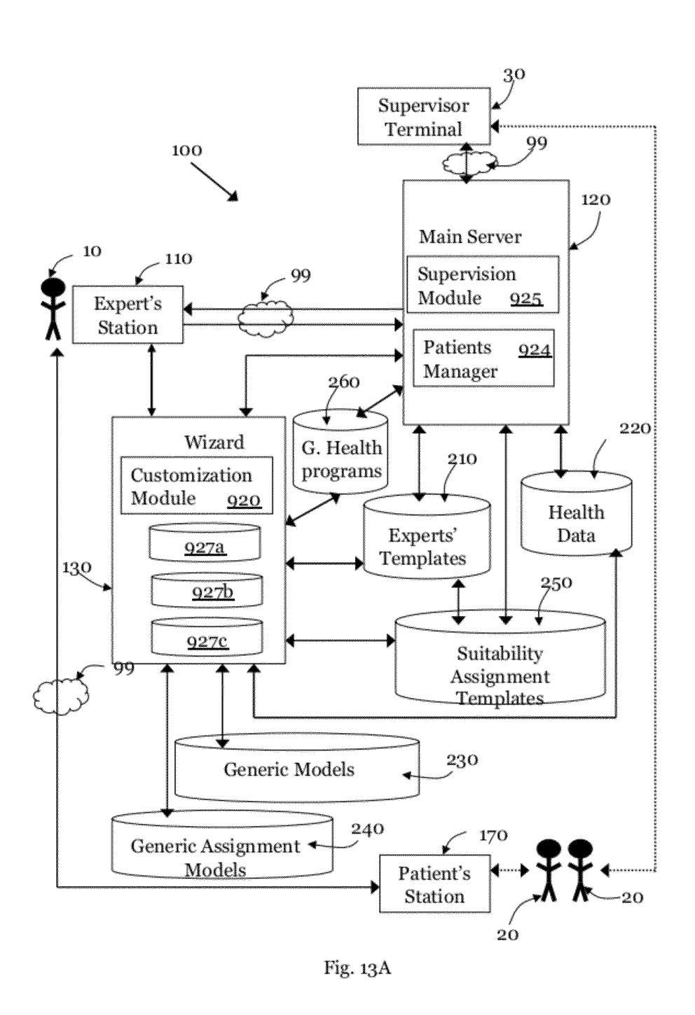

FIG. 12 is a flowchart, schematically illustrating the process of retrieving and presenting suitable care plans to a patient according to the patient's related health data and goal, according to some embodiments of the invention. The process may comprise:

receiving patient's profile including health parameters and personal properties 821;

receiving at least one patient's health related goal 822;

retrieve suitability assignment templates 823 (e.g. from the at least one suitability assignment templates database 250);

identifying care plans that are not excluded by the exclusion criteria of each of the plans 824 (e.g. by going through all plans in the at least one templates database 230);

identifying the most suitable plans out of the non-excluded plans according to each non-excluded plan's suitability factor 825 (e.g. using the patient's received personal and/or health properties);

calculating/identifying the effectiveness rate of each plan of the most suitable plans in relation to the patient's received health related goal 826;

retrieving a predefined number “N” of the most suitable health related plans (e.g. the suitable plans with the highest effectiveness rate) 827;

present the titles and description of the most suitable plans 828;

selecting at least one of the displayed plans (where the user can carry out the selection) 829;

retrieving the selected care plan 830 (e.g. from the care plans database 210); and

presenting the details of the selected care plan 831.

Additionally, the selected care plan may be activated 832 enabling to the user (e.g. the patient 20) to follow the plan and monitor the patient's following and implementation of the plan.

According to some embodiments of the present invention, there are provided a system and a method for supporting health related programs by enabling experts, using expert end terminals also referred to as expert stations (such as a computer, smartphone, tablet device etc.) to create and define generic health programs and patients (also referred to hereinafter as “participants” or “users”) using patients' terminals also referred to as patient stations (such as computers, smartphones, tablet devices etc.) to input their personal details and automatically receive health programs adapted to their personal parameters. Each health program is an actionable program including actionable care plans such as schedule-based tasks that can be followed and monitored over time by the system through one or more supervisor terminals manned by human supervisors to monitor and supervise the user's participation in the health program, provide the patient with a relevant feedback, information relating to the program, updates of the program in accordance to his/her progress giving the patient a full supervision and program support if and when required.

A generic health program is a software based program that includes instructions structured as a set of rules and commands operable according thereto in a generic manner that allows operating the commands and/or changing their respective parameters according to received data, such as according to input parameters associated with a specific patient. The input data allows automatically adapting the generic program to the specific patient personalizing it thereby to fit the personal characteristics of the specific patient such as to the patient's age, weight, gender, BMI, medical condition, selected goals and the like.

According to some embodiments of the present invention, some of the actions are scheduled according to a predefined timeline such that the actions preceding other actions trigger their related succeeding action(s) according to the timeline and optionally depending on the progress level of the preceding action (e.g. how well or if it was indicated as performed) allowing the respective patient to be able to receive and operate the respective health program and care plans thereof using his/her terminal device while the actions are triggered according to the timeline and other rules and conditions defined by interrelations between actions of the care plan/health program.

According to some embodiments of the present invention, the system and method allow the expert to create actionable care plans by enabling the expert to create recommendations through a specially designed computerized platform (i.e. designated software application) allowing the expert to define/create a set of actions such as tasks, for each recommendation. Each action or recommendation can be retrieved from a ready-made actions archive and recommendations archive (e.g. associated with the specific expert and/or field of expertise, recommendation type, etc.), respectively, or created by the expert, using the computerized platform, which allows defining recommendations, actions and interrelations therebetween, according to predefined rules and definitions (i.e. settings).

According to some embodiments, the system includes a support platform installed at a main server that supports an expert wizard, a supervisor application and one or more user applications for patients. The support platform may be browser-based allowing for it to be used in or by various browsing applications, engines and the like such as Google Chrome, Microsoft Explorer or Mozilla Firefox, for instance.

The system allows users to input personal details and/or create “observations” through a designated input platform (i.e. user interface). An observation is defined as a basic data of the patient, such as height, weight, blood test results, etc. An “Observation” can be a measurement, numeric value, Boolean state or a text string that can be stored in the system's database.

According to some embodiments, there are two basic types of observation values: (i) collected and (ii) calculated. Collected Observations are the raw data inputted by the users/participants, where the Calculated Observations are the result of an interpretation or calculation executed using the inputted data (such as calculating BMI from input height and weight of the user). The observations (calculated and/or collected) are used to generate profile of the respective patient (i.e. use or participant).

A patient profile is defined as a high-level indication regarding a patient, such as “Cardiovascular risk” or “Metabolic profile” the profile can be calculated or deduced from the input and/or calculated details of the observation thereof. A participant typically has more than one Profile. Profiles contain Indexes that indicate the contribution of each of the patient's observation to the profile and the medical meaning and/or other interpretation of the profile itself. \

An index is defined as a combination of observations that indicates a particular interpretation of the observations. For example, indexes are defined by the acceptable (normal) ranges of particular Observations. For every Index, the system can show a progression and rating that allows the users to make judgment regarding whether the index requires improvement or whether it is trending in a positive direction. Each index may be associated with one or more possible “index states”.

An index state is defined as an interpretation of the state of a particular Index. For example, it may indicate a “high” or a “low” risk for a particular disease, or “normal”, “over” or “under” a normal weight or height etc. The Index State takes all the conditions (parameter ranges referred to hereinafter as Range-Groups) that could be considered appropriate for that Index, and aggregates them or compares them with the normal ranges to see if they exceed them in relation to other profile related information. For example, for “normal weight range”, you would have normal ranges for people of particular heights as related to their weight, categorized by male/female and according to age. This entire set of Range-Groups for “normal weight” would be aggregated into the Index called “normal weight”.

The term “interpretation” referred to in this application relates to any calculation performed over the Observations of a particular participant, in order to apply a particular Profile or Profiles to the participant/patient. An interpretation allows making a judgment on the Observation for creating an action item. For example if a particular Observation increases above a certain percentage, the Interpretation would be a trigger for sending a warning to the patient.

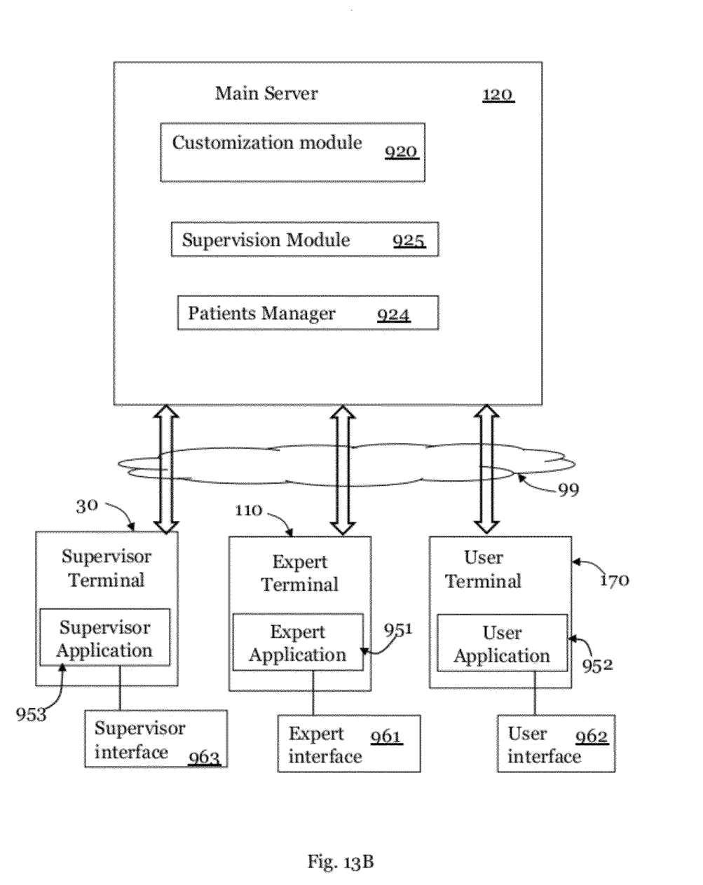

Reference is now made to FIG. 13A, which is a block diagram schematically illustrating the system 100, as illustrated in FIG. 1, where the other station(s) 30 is dedicated to one or more supervisor terminals 30, wherein the main server 120 supports a supervision module 925 and a patients manager 924 for enabling converting the generic health programs generated by the experts 10 using the wizard 130, which may also be operated by the main server 120 or by another server communicative therewith. The wizard 130 inter alia, allows an expert 10 to create generic actionable health programs by using thereof and store them or parts thereof such as recommendations and actionable care plans in the database 260. Each or some of the generic health programs, recommendations and/or care plans allow/s automatically transforming into a personal respective program, recommendation and/or care plan by being able (through its conditions, interrelations and code) using the profiles.

The wizard 130 includes a customization module 920 that allows the expert 10, using his/her expert station 110, to generate generic health programs consisting of multiple related generic care plans, interpretation rules and target setting rules and store them in one or more shared databases such as database 260. The suitability customization allows the patient to select the most suitable health program, where the patient manager 924 allows personalizing the selected suitable generic health program by using the profile of the respective patient to set conditions, rules and/or parameters of the care plans of the selected health program accordingly for personalization thereof

The interpretation rules are a set of computer program commands and instructions determine how the patient's personal details such as input data and/or observations are interpreted to create the patient's profile, determining the indexes of the patient and the like, according to a generic template associated with the expert's views and expertise. The target setting rules are a set of computer program commands and instructions for setting personal targets on indexes of a patient. For example, for a patient having an index of “Glucose”, the rules may be set by the expert that if the patient's glucose level exceeds a defined threshold (e.g. G>125 mg %) the health program sets a target for “reaching the normal glucose level of equal or below the defined threshold”. According to some embodiments of the present invention, each possible target of a health program is associated with a set of interrelated care plans so that once the rule of a target is confirmed (e.g. the threshold is exceeded), the health program automatically operates/executes the associated set of care plans until another condition, defined by the expert, is fulfilled such as if the threshold value is reached.

According to some embodiments of the present invention, the patient manager 924 also allows creating patients' profiles using patients' input parameters and observations, for example. This means that each generic program and/or care plan is designed and programmed as a set of conditions and commands that allows receiving observations of the respective patient in a specific format and personalizing the care plans and recommendations thereby automatically. The personalization may include, for instance, adapting the timeline scheduling of the care plans and/or other aspects of interrelations thereof, the goals of each action, the dosages of medication and the like according to the received profile parameters of the patient.

Reference is now made to FIG. 13B schematically illustrating how the wizard 130 including the customization module 920 operated thereby and the supervision module 925 and patients manager 924 are operated by the main server 120, according to some embodiments of the present invention.

According to these embodiments, the main server 120 also supports expert, supervisor and user applications 951, 952 and 953 respectively, operated through expert, supervisor and user terminals 110, 30 and 170 respectively. The applications 951-953 may be installed at the respective expert, supervisor and user terminals 110, 170 and 30 or be operated as web applications through a main website supported, maintained and operated by the main server 120.

According to some embodiments of the present invention, the main server 120 operates a number of software based modules through one or more computer processors for (i) allowing users (i.e. patients or participants which may be patients' caretakers for example) to input health related personal data; (ii) allowing experts to build generic health programs using a single unique computerized platform provided thereby; (iii) allowing the users to then follow and perform these health programs; and (iv) allowing supervisors to supervise the progress of the patients in performing or following their health programs.

As illustrated in FIG. 13B, the customization module 920 allows experts 10 to build generic health programs by using their expert terminal 110 (such as a computer, smartphone, tablet device etc.) through a designated expert application 951 having a unique designated interface 961 associated with the customization module 920 of the wizard 130.

According to some embodiments of the present invention, the patients manager 924 supports a user interface 962 applicable through the user terminal 170 (such as a computer, smartphone, tablet device etc.) e.g. through the user application 952 installed at (e.g. uploaded to) the user terminal 170 and/or through a website accessed to by using the user terminal 170 supported by the main server 920.

A supervisor using a supervisor terminal 30 (such as a computer, smartphone, tablet device etc.) can be provided with a supervisor application 953 having a designated supervisor interface 963 allowing the supervisor to supervise multiple health programs used by multiple patients therethrough.

The main server 120 may include or have access to various databases such as a profiles database 927a including experts' pofile creation programs defining how the input parameters of the patients/users are translated into profiles to later on be used by the care plans for defining features thereof; a programs database 927b for allowing the experts to store a multiplicity of generic health programs/care plans, recommendations and their associated actions and optionally also their associated content and/or other information related thereto, they have created, to allow other or the same experts to be able to retrieve recommendations and their associated actions and information for constructing new personal health programs.

Other data storage units such as content database 927c may be used for storing any other relevant related information, algorithms etc. such as for storing uploaded content, indicators of webpages including relevant content (e.g. URL addresses) and the like. The content can include educational material that is aimed for educating the patient in respect to his/her physical condition and what can be done to improve it or how to maintain a healthy life style even when the patient does not suffer from a specific condition such as obesity, disease and the like. The content may be textual, video, audio and the like or a combination thereof. For example, a recommendation or an action relating to dieting may be presented along with a textual content explaining the benefits of healthy eating as well as a link to an online video discussing the same subject.

According to some embodiment, the customization module 920 can create content groups by associating each content source or its link (e.g. URL) to one or more field groups related to various content fields and optionally sub-fields such as content related to the field of physical exercise and to the subfield of physical exercise to diabetes patients. If the content group is already created before a new content is uploaded to a designated content storage of the server 900 the customization module 924 may enable the expert to associate the content to the group while it is uploaded.

According to some embodiments of the present invention, the patient manager 924 receives the patient's input data and operates the respective health program by allowing it to automatically personalize and execute its care plans according to the personal input data of the patient. This is done, as mentioned above, by executing the interpretation rules for determining the patient's indexes and parameters, the target setting rules and optionally other instructions associated with actionable care plans that are not necessarily associated with specific targets.

Translating input parameter values (i.e. inputted observations) with the profile and its associated indexes is carried out automatically according to a predefined manner in which the profile indexes and index states are stored and defined in the system 900. The data configuration of the profiles and the manner in which they are stored in the database 927a allows easy building and configuring of the recommendations and their actions for creating personal health programs.

According to some embodiments of the present invention, the system 900 provides an expert interface 961 operable through one or more types of terminal devices such as PC, smartphones, tablet devices and the like through various communication links such as the internet, WAP and the like. The expert interface 961 is a computerized expert platform (i.e. based on software, hardware or a combination thereof) that provides wizard tools for the expert to build actionable health programs by using predefined specific configuration options involving the recommendation structures that allow defining and associating actions (i.e. tasks) elements, content elements and other optional additional elements such as monitoring definitions and settings, alerts, definitions for setting of action tracking and enabling changes in action settings according to the performances of the actions of the specific patient over time, automatic feedback and incentives definitions (healthies) and the like. According to some embodiments of the present invention, the expert interface 961 allows the expert to schedule each or some of the actions and define interrelations between the actions and optionally also between recommendation, stages and/or care plans. The interrelations between actions and recommendation may include scheduling relations, meaning that some actions may be set according to a timeline, such that each action over the timeline triggers the other action when its schedule has passed and/or according to other or additional rules. The triggering rules may include, for example, conditions for triggering the next action e.g. only when the preceding action was fulfilled. The expert interface 961 may include a graphical computer interface tool allowing the expert to arrange the scheduling order of the actions or each recommendation and of the recommendations themselves by defining the time-related interrelations between those elements, for example, by placing the actions/recommendations over the time line. The conditions for triggering the action (e.g. setting an alarm making the action appear etc.) may be set by the expert using a designated setting tool. Once the interrelations between the program's elements are set by the expert, using the expert interface 961, the health program is stored at a designated storage such as a designated programs database in a data structure that corresponds to the structure of the specific health program (i.e. according to the interrelations between the elements and the schedule and/or priority hierarchy therebetween).

The system 100 may further provide a user interface 961 operable through one or more types of terminal devices such as PC, smartphones, tablet devices and the like through various communication links such as the internet, WAP and the like. The user interface 961 is a computerized platform that allows the user/patient to receive and operate the personal health program by presenting elements thereof such as the program's recommendations and their associated actions and content of the health program and additional elements such as feedbacks, incentive elements (e.g. content or effects that are placed along the health program over time to encourage the patient to carry on with the program and carry out the actions or view the provided relevant content). The user interface 961 also allows the patient to insert his/her own input through predefined input elements such as feedback input elements allowing the patient to input rating and/or textual feedback on each recommendation and/or action and/or content provided to him/her; enter progress related input such as done/undone indication for each action (i.e. task); and the like.

The supervision module 925 receives progress related information from the user applications 952, analyze the received progress related data and provide feedback to each respective patient (user) through the user application 952 such as grades, awards for identified positive performance of the actions, incentive feedbacks when progress is low, and the like. In some embodiments, the supervision module 925 provides interactive feedbacks requiring the patient to respond thereto to acknowledge response to the health program in general. For example, if an action was not marked by the patient as “done” after a predefined period, the supervision module 925 sends an interactive message inquiring regarding the specific action or entire progress/responsiveness where the message includes an interactive box requiring the patient to respond to it by pressing a virtual “dismiss” button or pressing the “enter” key and the like. To supervise the multiple patients or users, the supervisor application 953 includes and supports a designated supervisor interface 963 including various tools such as graphical user interface (GUI) tools allowing the supervisor, for example, to view graphical representation indicative of the specific user's progress in the health program/care plan and optionally tools that also allow the supervisor to view the progress of multiple users over the same one or more graphical representations.

According to some embodiments of the present invention, as illustrated in FIG. 13B, the expert application 951 also supports and includes an expert interface 961 allowing the expert to use GUI and other tools for building and editing generic care plans and health programs as well as to define profile building.

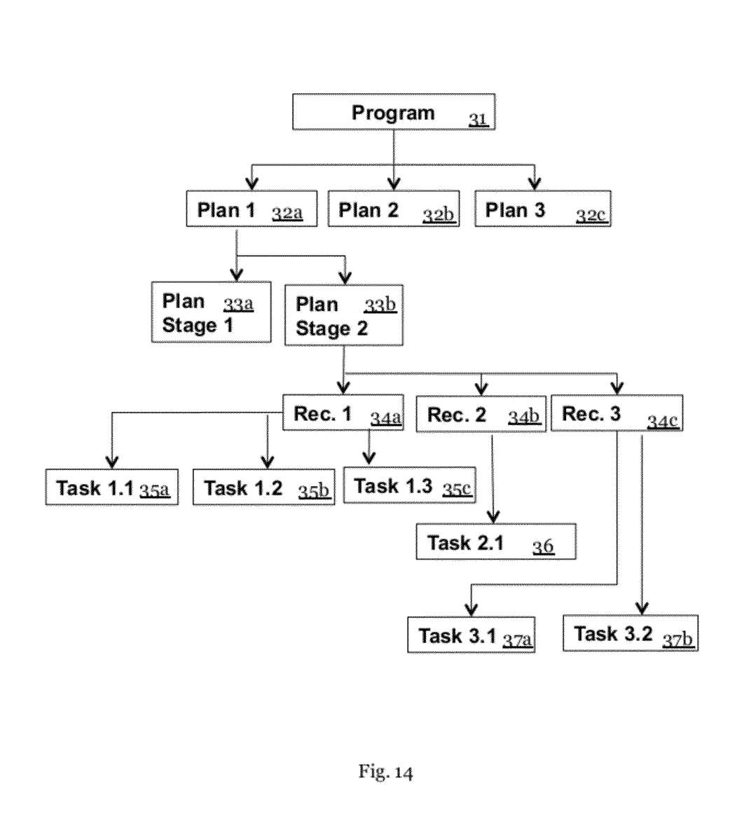

Reference is now made to FIG. 14, which is a schematic illustration of the hierarchal structure of an actionable health program 31, according to some embodiments of the present invention. The health program 31 may have a multiplicity of care plans associated therewith such as care plans 32a, 32b and 32c, each care plan may be associated with one or more stages. FIG. 14 illustrates how one of the care plans—care plan 31a is associated with two plan stages 33a and 33b. The plan stages may indicate the effort or difficulty level of the actions that are associated therewith allowing the patient to progress the program 31 through stages. Each plan stage, such as plan stage 33b is associated with one or more recommendations such as recommendations 34a, 34b and 34c. Each recommendation may include a tiltle indicative of the recommendation itself, the difficulty/effort level and the number of actions associated therewith. As mentioned above, each recommendation is associated with one or more actions that can be tasks such as tasks 35a, 35b and 35c which are associated with the first recommendation 34a; task 36 which is associated with the second recommendation 34b; and tasks 37a, and 37b which are associated with the third recommendation 34c. One or more of the program's recommendations may also be associated with additional elements such as relevant content, links to webpages including relevant contents, user ranking input options and the like.

To further illustrate a possible health program configuration and hierarchy, we can take an exemplary health program, which is a Diabetes Management Program. In this example, the DMP includes three care plans: (i) a physical activity plan—including personal recommendations related to physical activity; (ii) a nutrition plan—including personal recommendations related to dieting; and (iii) a disease management plan—including personal recommendations related to medical treatment and monitoring. Each care plan addresses a different aspect of the disease management. For example, the nutrition care plan includes three stages, where one of the stages can include recommendations such as: (a) count carbs; (b) maintain food log; and (c) avoid trans-fat. Each recommendation is associated with actions for helping the patient to actually follow the associated recommendation. For example, the “count carbs” recommendation may be associated with tasks such as: (i) a quiz for allowing assessing the daily carb intake of the patient; (ii) an interactive diet in which the patient is required to input which of the recommended foods he/she had for each meal and input (e.g. via a text input field) additional non-recommended foods he/she had consumed that day.

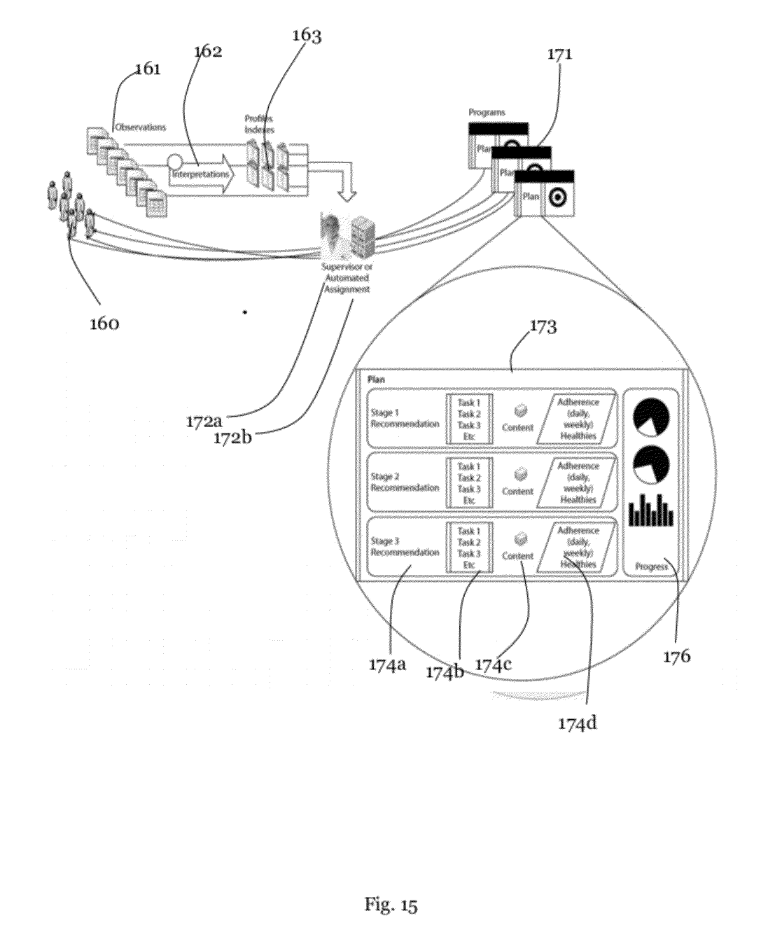

Reference is now made to FIG. 15, which illustrates a data flow showing how generic actionable health programs can be built by experts, used by patients 160, and monitored by supervisors according to some embodiments of the present invention. As mentioned above, the patients (i.e. users using their user terminals) can input data such as personal details (age, sex, height, weight know diseases etc.), where the system (e.e. via a main server 175) can use some of the input data to calculate other parameters such as BMI all received by the system as “observations” 161, which may be stored in the system. The observations 161 of the specific patient are then translated or interpreted into profile(s) of the patient according to profile indexes set by the expert. To allow the expert to use these profiles 163 of the patient for building one or more personal health plans for this patient 160, where each health program 171 includes one or more care plans such as care plan 173 includes multiple actionable recommendations. As illustrates in FIG. 15, a care plan such as care plan 173 includes multiple stages each is schedules according to its level and number. Each plan stage includes multiple recommendations 174a, associated with task actions, relevant content or links directing thereto and optionally also to adherence related data 174d. Optionally, the system allows presenting to both the patient 160 and the expert progress related information wither textually, graphically (e.g. through a progress scale 176), aurally and/or in any other way. The outputted progress related data indicates the adherence of the patient to the program and may also indicate the efficiency of the program by, for example, enabling to track the patient weight and/or BMI values over time in response to the program. The progress of the patients 160 in executing and performing their actions (e.g. tasks) can be monitored by the supervisor 172a using a supervisor terminal 172b (e.g. server) who can mediate the programs and the patients, as illustrated in FIG. 15.

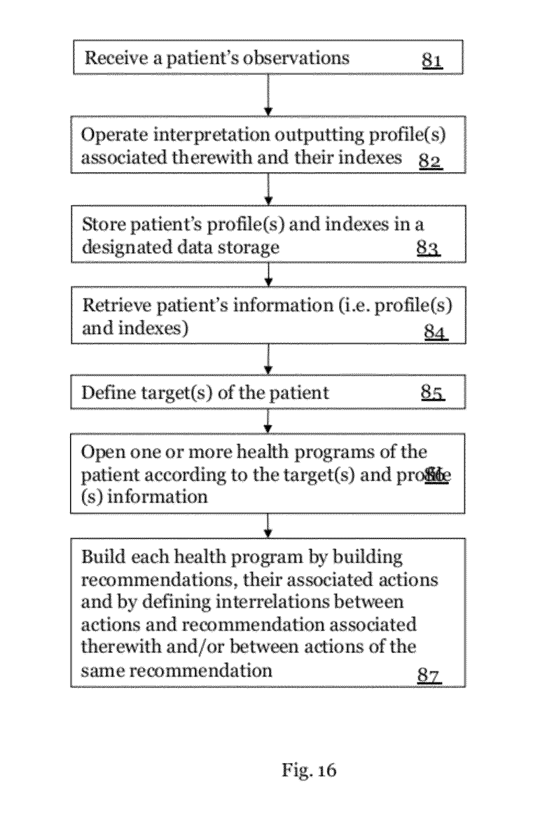

Reference is now made to FIG. 16, which is a flowchart, schematically illustrating a process of building personal health programs and using them, according to some embodiments of the present invention. According to these embodiments a patient's observations are received 81 (e.g. by the support server and designated support software and/or hardware application), indicative of the patient's personal details (such as weight, age, gender, height etc.) and optionally also of the patient's measured parameters such as blood test results, blood pressure, DNA (genetic) data and the like. Once the observations are received at least some of them are processed by the server and application to interpreted them into profile(s) of the patient 82 according to the specific profile structure (i.e. including the profile indexes) of the system (for example, according to a predefined data hierarchy and analysis options). The indexes may be calculated/assessed using a designated indexing algorithm that can deduce the medical/physical status of the patient according to the inputted parameters and information and/or parameters calculated by using the input parameters. For example, the medical condition(s) of the patient may be calculated according to the patient's blood test results, BMI value (calculated according to the patient's inputted weight and height) and according to the patient's inputted gender and age. All these factors are required to estimate, for instance, the severity of the patient's condition. The assessment of the indexes may be carried out manually be an expert in the field (such as a physician, a dietician or a certified nurse) and/or automatically be the indexing algorithm depending of the type of analysis required and the level of professional level and experience required to carry out the particular assessment, which may be determined by the expert and/or by the algorithm. To simplify the process the patient may be required to input any known diseases and his/her personal health related goals to allow the system to automatically refer the patient's inputted observations to the right expert(s). Additionally or alternatively, the health goals, which may be used to assess the target of the programs assigned to the specific patient, may be deduced from external processes such as described above.

Once the profiles and their associated indexes are created they can be stored in one or more storage units 83 (such as profiles database) and then retrieved by or sent to one or more experts 84, which in turn use the data and the data structure of the profiles and indexes of each respective patient to build one or more personal health programs thereto. The process of building each such program is very generally described in steps 85-87: the expert may be required to first define the target(s) that should be achieved by the health programs in respect to the patient's assessed condition 85, according to target definition system options and wizard tools. For example, some of the targets may include setting threshold value(s) such as target weight/target BMI and the like using a graphical target settings tool allowing the expert to graphically set the target(s) threshold level(s). The expert can then use the system to open and build a new health program 86-87 and assign it to the particular patient (e.g. assign it to a user name indicative of the patient). The building itself involves defining recommendations and their associated actions, defining which recommendation is associated with which care plan and which stage thereof and also optionally, assigning links and/or content data to each recommendation; defining feedback, supervision and incentive settings and the like.

According to some embodiments of the present invention, the system further includes an administrator application allowing an administrator to add or change the expert application, tools and/or definitions such as to add or change the observation and/or indexes types the system can receive as an input and/or define, respectively.

According to some embodiments of the present invention, the expert interface 961 may allow the expert to define program elements such as care plans, recommendation and actions of a specific program and interrelations therebetween, according to predefined one or more optional structures. For example, the expert may be required to provide a “stage name” to each stage or leave a default stage number title and to assign a duration prediction to each or some of the stages. The wizard tools of the expert interface 961 may additionally require the expert to allocate a recommendation title to each new recommendation of the program or to check and update titles of retrieved recommendations as well as assign each recommendation with a weight value. The weight of each recommendation indicates its importance in respect to the other recommendations of the specific care plan or to all recommendations of the specific health program. Optionally, the title of a recommendation describes the recommendation and also includes information indicative of the reasoning or rational behind the recommendation and/or tips/explanations as to how the recommendation can be accomplished.

The task actions are used for one or more of the following purposes: (i) for measuring adherence to the associated recommendation thereof and therefore being able to provide feedbacks to the patient (e.g. through awarding the patient and/or encouraging him/her through incentives and graduated targets; (ii) for simplifying and clarifying the recommendation and how it can be accomplished or followed; (iii) for adding an entertainment aspect to the health program by allowing interacting with the patient through the actions and monitoring progress thereof through the actions.

According to some embodiments, the feedback includes granting “healthies” defined herein as “incentive points” awarded to patients for different events, such as completing tasks, adhering to the plan, etc., depending on the configuration of the system, where the events are measurable features of the tasks/actions such as the time it took the patient from accessing the task and program until the specific task was marked “done” by him/her, the average number of calorie intake of the patient as calculated according to a diet log filled by the patient, and the like.

As mentioned above, the system may support experts and patients (i.e. users) that use touch screen based communication devices such as tablet devices and/or smartphones. To allow such support, computer modules (which may be software components, hardware components or a combination thereof) operated through the support server 920 are adapted to additionally or exclusively support such terminal devices.

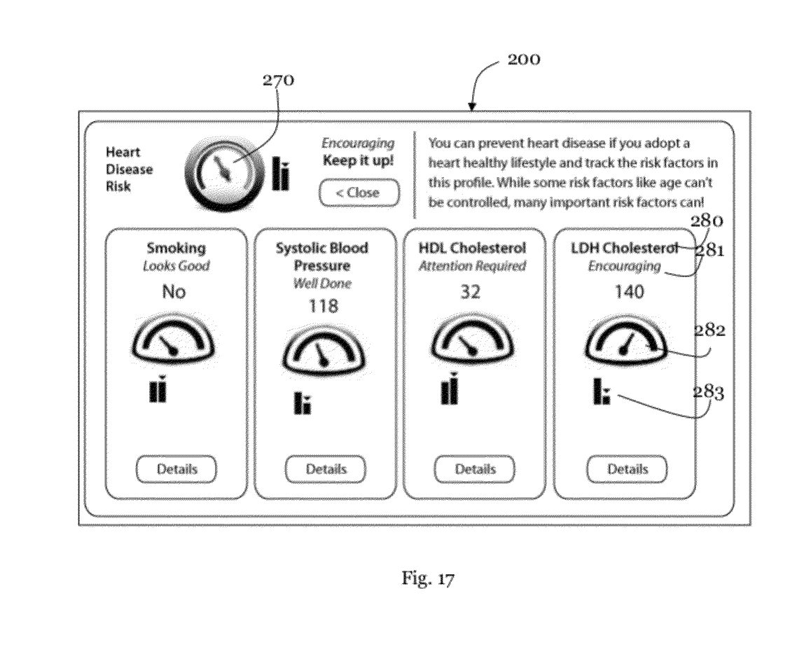

FIG. 17 shows a graphical display of a patient's profile 200, displayed for the expert and/or the respective patient according to some embodiments of the present invention. The profile 200 includes the name of the specific profile: e.g. “Heat Disease Risk” and textual description thereof and various objects indicative of various personal physical (observations) and/or program-progress related parameters of the patient. For example, the profile 200 shows an adherence gauge 270 indicating the patient's adherence rate, which is related to the manner in which the patient is progressing in his/her health program. This adherence indicator(s) of the specific program is(are) calculated according to predefined methods set by the expert. The observations may be represented through indexes indicative of the risk factors for heart diseases, in this example, such as “smoking” systolic Blood Pressure“, HDL cholesterol” and/or LDL cholesterol” 280. Each index includes a representation of the parameter level or status (e.g. LDL cholesterol measure indicated by a number 281; a graphical representation 282 of both the measure of the index as well as the normal-range as set by the expert; a link button 283 for accessing more details of the specific index.

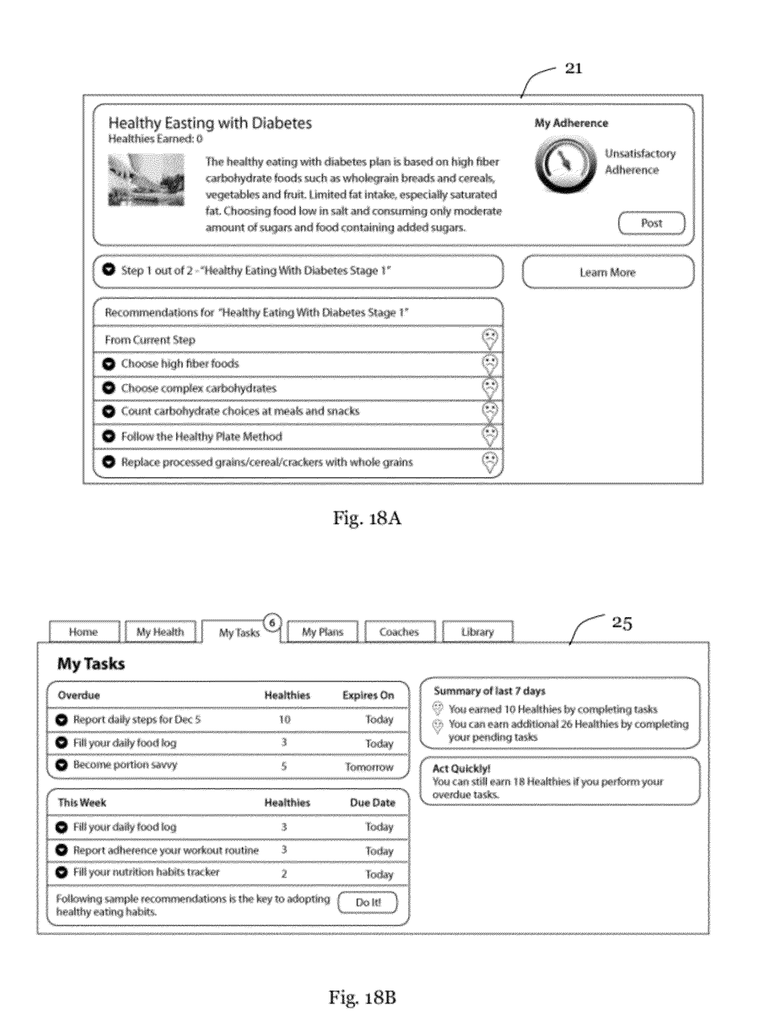

FIG. 18A shows a first stage 21 and its associated recommendation list of a diabetes management program including multiple recommendations associated with healthy eating, according to some embodiments of the present invention.

FIG. 18B shows a task manager 25 of a specific recommendation, according to some embodiments of the present invention, providing the patient with timed tasks (e.g. some daily tasks, some weekly etc.), for example, allowing the patient to daily/weekly report or indicate regarding the status of each task. This in turn allows the patient himself/herself and the expert to monitor the patient's progress by presenting the patient and the expert with adherence information indicative of the patient's tasks fulfillment, measured progress (e.g. weight, BMI, blood pressure measures, motivational state and the like.

According to some embodiments of the present invention, the system also provides feedback to the patient including for instance, messages (e.g. encouragement messages during the program), indication of dangerous physical condition, alarms for reminding the patient to carry out some of the tasks and the like, through the patient terminal.

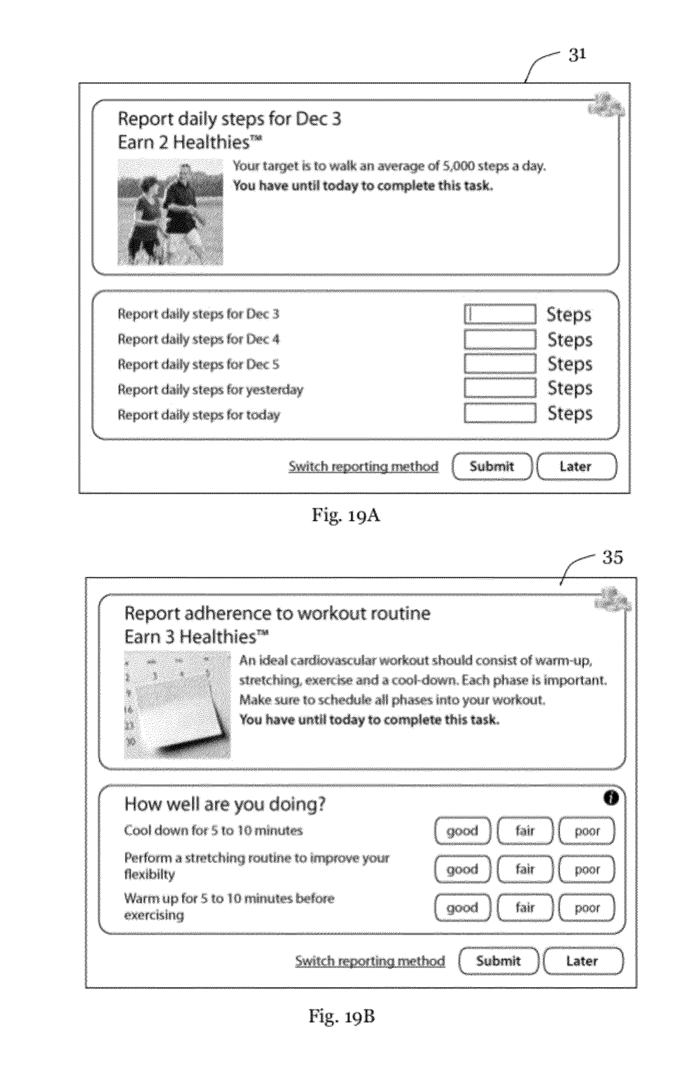

FIG. 19A shows a specific task representation 31 requiring reporting adherence related information therethrough, according to some embodiments of the present invention.

FIG. 19B shows a progress representation 35 associated with the task representation of FIG. 19A, according to some embodiments of the present invention.

The expert can monitor each patient of his/her separately as well as all his patients to receive personal statistics of his/her patients' progress. According to some embodiments of the present invention, the expert application 951 through the support server 920, allow the expert to provide personal online feedback to each of his/her patient through messaging, direct phone communication and the like.

Additionally or alternatively, the user application 952 allows the patient to communicate with the expert via messages and/or through a direct call applicability embedded in the application 952 such as through internet call applications such as Skype. This enables the expert and patient to directly communicate with one another to allow the expert to best support the patient when performing health program thereof.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

1. A system for building and supporting health related programs, said system comprising:
a) a computerized support platform comprising at least one processor that operates a wizard for allowing experts, using expert terminal devices, to build generic health programs for patients, each said generic health program comprises instructions structured as a set of rules and commands operable according thereto in a generic manner that allows operating the commands and/or changing their respective parameters according to received data, wherein each respective health program comprises actionable care plans; and
b) at least one data storage for enabling storage and retrieval of generic health programs including said respective actionable care plans thereof,
wherein the generic configuration of the health programs allows said support platform to automatically personalize each respective said health program for a specific patient by receiving personal input data of the respective patient and adapting the care plans of the respective health program, according to the respective health program's instructions and the input data.

2. The system according to claim 1, wherein said wizard allows the expert to define actions of care plans and interrelations therebetween by providing and supporting an expert interface, said interrelations comprise stages according to which said actionable care plans are executed.

3. The system according to claim 2, wherein at least some of said actions are scheduled according to a timeline, in which some of said actions preceding other actions trigger said respective other actions according to said timeline—, said timeline defines said care plans stages of the respective health program.

4. The system according to claim 1, wherein said instructions of each generic health program comprises a set of interpretation rules and target setting rules, wherein said interpretation rules determine how input data of the patient is interpreted for determining indexes of the respective patient; and said target setting rules enable associating at least one target to each index set according to said interpretation rules, each respective set target is associated with a set of interrelated care plans and allows executing and operating said respective associated care plans set in respect to said target.

5. The system according to claim 1, further comprising a patients manager and a supervision module, said patient manager allows adapting the generic health programs to each respective specific patient by using observations inputted by the patient and creating respective patients' profile thereby, and said supervision module allows a supervisor, using a supervisor terminal to supervise the patients in performing their respective personal health programs.

6. The system according to claim 5, wherein each said health program also comprises a feedback layout allowing providing feedbacks to the patient in relation to the patient performances, wherein at least some of said actions are associated with feedback options triggering automatic feedbacks in relation to various progress situations, said feedback comprises awarding the patient with incentive healthies ranks.

7. The system according to claim 5, wherein said supervision module enables the supervisor to provide online feedback to his/her patients.

8. The system according to claim 1, wherein said support platform supports expert applications operated by experts' terminal devices and patient applications operated therethrough, wherein said expert application allows the expert to build health programs, monitor and feedback his/her patients through his/her terminal device using a designated expert interface and the user application allows the user to operate personal health programs and to receive feedback through his/her user terminal device using a designated user interface.

9. The system according to claim 1, further enabling the expert to associate content to each recommendation and/or action, wherein once operating the respective health program each recommendation or action that is associated with content is presented with its associated content or content indication.

10. The system according to claim 9, wherein said wizard further allows the expert to assign content or an indication linking thereto.

11. The system according to claim 1, wherein each profile is created by receiving input data from each respective patient and calculating observations based on said input data, said observations are then used to build the patient's respective patient's profile by using a designated profiler module operable through said support platform.

12. The system according to claim 1, wherein care plans of a specific health program are configured in a hierarchal structure.

13. The system according to claim 1, wherein said support platform further enables presenting the user with optional multiple suitable health programs selected from said data storage, wherein the suitable health programs are selected by the support platform according to predefined suitability conditions depending on said input data.

14. A method for building and supporting health related programs, said method comprising:
a) providing a computerized support platform operating a wizard for allowing experts to build generic health programs;
b) building generic health programs for patients, wherein an expert uses said wizard through an expert terminal to build said generic health program, wherein each said generic health program comprises instructions structured as a set of rules and commands operable according thereto in a generic manner that allows operating the commands and/or changing their respective parameters according to received data, wherein each respective health program comprises actionable care plans;
c) storing generic health programs including said respective actionable care plans thereof in at least one data storage;
d) receiving input data of a patient from at least one user terminal; and
e) automatically personalizing at least one health program by adapting the respective generic health program according to commands and instructions thereof and according to the received input data.

15. The method according to claim 14, further comprising supervising the progress of patients in performing their respective personal health programs, using a supervision module of the support platform used by a supervisor.

16. The method according to claims 14, further comprising providing feedbacks to the patient in relation to the patient performances, wherein at least some of said actions are associated with feedback options triggering automatic feedbacks in relation to various progress situations, said feedback comprises awarding the patient with incentive ranks.

17. The method according to claim 15, further comprising providing online feedback to patients, said expert enables providing such feedbacks through messaging and/or direct call communication enabled by said supervision module.

18. The method according to claim 14, wherein building a respective said health program further comprises associating content to at least one the health program's care plans, wherein once operating the respective health program each care plan that is associated with content is presented with its associated content or content indication.

19. The method according to claim 18, further comprising assigning each relevant content or an indication linking thereto to at least one content group and/or sub group.

20. The method according to claim 14, further comprising creating a patient profile for each patient according to the input data thereof, using a patient application supported by a patients manager operated by said wizard, wherein said input data is translated into at least one observation, which is then used to build the patient's respective at least one profile by using a designated generic translation technique.

21. The method according to claim 14, further comprising selecting and presenting the user with optional multiple suitable health programs selected from said data storage, wherein the suitable health programs are selected by the support platform according to predefined suitability conditions depending on said input data.

22. The method according to claim 15, further comprising providing feedbacks to the patient in relation to the patient performances, wherein at least some of said actions are associated with feedback options triggering automatic feedbacks in relation to various progress situations, said feedback comprises awarding the patient with incentive ranks.
